(19) United States
(12) Patent Application Publication
(10) Pub. No.: US 2026/0188546 A1
(43) Pub. Date: Jul. 2, 2026

(54) SOFT MAGNETIC ALLOY, SOFT MAGNETIC ALLOY RIBBON, AND MAGNETIC DEVICE

(71) Applicant: TDK Corporation, Tokyo (JP)

(72) Inventors: Yuta NAKAGAWA, Tokyo (JP); Akito HASEGAWA, Tokyo (JP); Takuya TSUKAHARA, Tokyo (JP)

(73) Assignee: TDK Corporation, Tokyo (JP)

(21) Appl. No.: 19/434,486

(22) Filed: Dec. 29, 2025

(30) Foreign Application Priority Data
Dec. 27, 2024 (JP) 2024-232887

(51) Int. Cl. H01F 1/147; C01B 25/08

(52) U.S. Cl. CPC H01F 1/14708; C01B 25/088; C01P 2002/60; C01P 2006/42

(57) ABSTRACT

A soft magnetic alloy contains a main component having a composition formula (Fe_{(1-α)}X1_{α})_{(1-(a+b+c+d+e+f+g+h))}MₐB_{b}P_{c}Si_{d}CₑMn_{f}X2_{g}Oₕ. X1 includes at least one selected from the group consisting of Co and Ni. X2 includes at least one selected from the group consisting of Al, Ag, Zn, Sn, As, Sb, Cu, Cr, Bi, N, and a rare earth element. M includes at least one selected from the group consisting of Nb, Hf, Zr, Ta, Ti, Mo, W, and V. 0.02≤a≤0.10, 0.02≤b≤0.20, 0≤c≤0.10, 0≤d≤0.15, 0≤e≤0.03, 0<f≤0.02, 0≤g≤0.03, 0.0001≤h≤0.012, 0.05≤f/h≤100, and 0≤α≤0.5 are satisfied.

### TECHNICAL FIELD

The present invention relates to a soft magnetic alloy, a soft magnetic alloy ribbon, and a magnetic device.

### BACKGROUND

In recent years, there has been a demand for lower power consumption and higher efficiency in electronic, information, or communication equipment or the like. The demand is further increasing to achieve a low-carbon society. Thus, power supply circuits of electronic, information, or communication equipment or the like are required to have less energy loss or higher power efficiency.

A magnetic core of a magnetic element included in a power supply circuit is required to have higher saturation magnetic flux density, less core loss (magnetic loss), and higher permeability. Reduction in core loss reduces electrical energy loss. Increase in saturation magnetic flux density and permeability can downsize the magnetic element. This improves efficiency and saves energy. One conceivable method of reducing the core loss of the above magnetic core may be increasing the specific resistance of a constituent magnetic body of the magnetic core and reducing eddy current loss.

Patent Document 1 discloses a soft magnetic alloy having high specific resistance, high saturation magnetic flux density, and low coercivity by having a specific crystal structure.
Patent Document 1: JP Patent No. 6614300

### SUMMARY

The present invention has been achieved in view of such circumstances. It is an object of the invention to provide a soft magnetic alloy with high specific resistance, high saturation magnetic flux density, and low coercivity using a means different from a conventional means.

To achieve the above object, a soft magnetic alloy according to one aspect of the present invention is
a soft magnetic alloy containing a main component having a composition formula (Fe_{(1-α)}X1_{α})_{(1-(a+b+c+d+e+f+g+h))}MₐB_{b}P_{c}Si_{d}CₑMn_{f}X2_{g}Oₕ, where
X1 includes at least one selected from the group consisting of Co and Ni,
X2 includes at least one selected from the group consisting of Al, Ag, Zn, Sn, As, Sb, Cu, Cr, Bi, N, and a rare earth element,
M includes at least one selected from the group consisting of Nb, Hf, Zr, Ta, Ti, Mo, W, and V, and

$$\begin{matrix}0.02 \leq a \leq 0.10 , \\ 0.02 \leq b \leq 0.2 , \\ 0 \leq c \leq 0.10 , \\ 0 \leq d \leq 0.15 , \\ 0 \leq e \leq 0.03 , \\ 0 < f \leq 0.02 , \\ 0 \leq g \leq 0.03 , \\ 0.0001 \leq h \leq 0.0 \; 12 , \\ 0.05 \leq f / h \leq 100 , and \\ 0 \leq α \leq 0.5\end{matrix}$$

are satisfied.

Because, for example, a Mn oxide (preferably MnO) is easily segregated at a surface of this soft magnetic alloy, the soft magnetic alloy can have high specific resistance, low coercivity, and high saturation magnetic flux density at the same time.

Preferably, 0.730≤1−(a+b+c+d+e+f+g+h)≤0.918 is satisfied. This range improves particularly the saturation magnetic flux density.

The value of α may be 0.

Preferably, the soft magnetic alloy contains a Mn oxide.

Preferably, the soft magnetic alloy includes a region containing the Mn oxide at or within 100 nm from a surface of the soft magnetic alloy.

The soft magnetic alloy may have a nanocrystalline structure. The nanocrystalline structure may include nanocrystals with an average crystallite size of 50 nm or less.

A soft magnetic alloy ribbon according to one aspect of the present invention contains the above soft magnetic alloy. The soft magnetic alloy ribbon may have any thickness but has a thickness of preferably 1 μm or more and 100 μm or less.

A magnetic device according to one aspect of the present invention contains the above soft magnetic alloy or the above soft magnetic alloy ribbon.

### BRIEF DESCRIPTION OF THE DRAWING(S)

FIG. 1A is a schematic view of a single-roll quenching ribbon manufacturing apparatus used for a single-roll method according to the present embodiment.

FIG. 1B is a schematic view of a nozzle opening of a quenching nozzle along a line IB-IB shown in FIG. 1A.

FIG. 2 is a perspective view of an example magnetic core as a magnetic device according to one embodiment of the present invention.

FIG. 3 is a graph showing results of a chemical-bonding state analysis with XPS according to one example of the present invention.

FIG. 4 is a graph showing changes in the Mn content according to the depth from a surface of a soft magnetic alloy according to one example of the present invention.

FIG. 5 is an example chart generated in an X-ray crystal structure analysis.

FIG. 6 is a plurality of example patterns obtained through profile fitting of the chart shown as FIG. 5.

### DETAILED DESCRIPTION

Hereinafter, an embodiment is described.

### First Embodiment

### Alloy Composition

A soft magnetic alloy according to the present embodiment is
a soft magnetic alloy containing a main component having a composition formula

$${( {Fe}_{( 1 - α )} X {1}_{α} )}_{( 1 - ( a + b + c + d + e + f + g + h ) )} {M}_{a} {B}_{b} {P}_{c} {Si}_{d} {C}_{e} {Mn}_{f} X {2}_{g} {O}_{h} ,$$

where
X1 includes at least one selected from the group consisting of Co and Ni,
X2 includes at least one selected from the group consisting of Al, Ag, Zn, Sn, As, Sb, Cu, Cr, Bi, N, and a rare earth element,
M includes at least one selected from the group consisting of Nb, Hf, Zr, Ta, Ti, Mo, W, and V, and

$$\begin{matrix}0.02 \leq a \leq 0.10 , \\ 0.02 \leq b \leq 0.2 , \\ 0 \leq c \leq 0.10 , \\ 0 \leq d \leq 0.15 , \\ 0 \leq e \leq 0.03 , \\ 0 < f \leq 0.02 , \\ 0 \leq g \leq 0.03 , \\ 0.0001 \leq h \leq 0.0 \; 12 , \\ 0.05 \leq f / h \leq 100 , and \\ 0 \leq α \leq 0.5\end{matrix}$$

are satisfied.

Hereinafter, each component of the soft magnetic alloy according to the present embodiment is described in detail.

M includes at least one selected from the group consisting of Nb, Hf, Zr, Ta, Ti, Mo, W, and V.

The M content (a) satisfies 0.02≤a≤0.10, is preferably 0.04≤a≤0.10, or is more preferably 0.05≤a≤0.08. A low “a” tends to reduce the specific resistance, increase the coercivity, and reduce the permeability μ′ of the soft magnetic alloy. A high “a” tends to reduce the saturation magnetic flux density of the soft magnetic alloy.

The B content (b) satisfies 0.02≤b≤0.20, may be 0.025≤b≤0.20, is preferably 0.06≤b≤0.18, or is more preferably 0.080≤b≤0.18. A low “b” tends to reduce the specific resistance, increase the coercivity, and reduce the permeability μ′ of the soft magnetic alloy. A high “b” tends to reduce the saturation magnetic flux density of the soft magnetic alloy.

The P content (c) satisfies 0≤c≤0.10, may be 0.001≤c≤0.10, or is preferably 0.003≤c≤0.10. The above range of P increases the specific resistance and reduces the coercivity of the soft magnetic alloy. Too high a “c” tends to reduce the saturation magnetic flux density of the soft magnetic alloy.

The Si content (d) satisfies 0≤d≤0.15 or is preferably 0≤d≤0.10. Containing Si tends to particularly increase the specific resistance and reduce the coercivity of the soft magnetic alloy. Moreover, an increase in specific resistance of the soft magnetic alloy enables a high permeability μ′ to be maintained even at a high frequency. A high “d” tends to increase the coercivity of the soft magnetic alloy.

The C content (e) satisfies 0≤e≤0.03, is preferably 0≤e≤0.025, or is more preferably 0≤e≤0.02. Containing C tends to particularly reduce the coercivity of the soft magnetic alloy and makes it easier to maintain a high permeability μ′ at a high frequency. A high “e” reduces the specific resistance and the saturation magnetic flux density of the soft magnetic alloy and conversely increases the coercivity. Moreover, it becomes difficult to maintain a high permeability μ′ at a high frequency.

The Mn content (f) satisfies 0<f≤0.02, may be 0.0001≤f≤0.02, or is preferably 0.0005≤f≤0.01. An “f” of 0 tends to reduce the specific resistance of the soft magnetic alloy. A high “f” tends to increase the coercivity and reduce the saturation magnetic flux density of the soft magnetic alloy.

X2 includes at least one selected from the group consisting of Al, Ag, Zn, Sn, As, Sb, Cu, Cr, Bi, N, and a rare earth element or preferably includes at least one selected from the group consisting of Zn, Sn, Cu, Cr, Bi, La, and Y.

The X2 content (g) satisfies 0≤g≤0.03. It may be that X2 is not contained.

The O content (h) satisfies 0.0001≤h≤0.012, may be 0.00011≤h≤0.010, or may be 0.0003≤h≤0.0050. An “h” close to 0 tends to reduce the specific resistance of the soft magnetic alloy because, for example, Mn at a surface of the soft magnetic alloy is less prone to be present as MnO. A high “h” tends to increase the coercivity and reduce the saturation magnetic flux density of the soft magnetic alloy.

The relation between the Mn content (f) and the O content (h) satisfies 0.05≤f/h≤100, may be 0.2≤f/h≤50, or may be 0.5≤f/h≤40.

X1 includes at least one selected from the group consisting of Co and Ni. The X1 content (α) may be α=0, i.e., it may be that X1 is not contained. In the present embodiment, the X1 content (α) is defined as a proportion substituting for Fe and preferably satisfies 0≤α≤0.5.

The (Fe_{(1-α)}X1ₐ) content, which is (1−(a+b+c+d+e+f+g+h)), is not limited but is preferably 0.730≤(1−(a+b+c+d+e+f+g+h))≤0.918. The above range of (1−(a+b+c+d+e+f+g+h)) makes it difficult to form crystal phases composed of crystals with a grain size of above 50 nm.

The soft magnetic alloy of the present embodiment may contain, as inevitable impurities, elements other than the above elements. The soft magnetic alloy may contain, for example, 0.1 wt % or less inevitable impurities out of 100 wt % soft magnetic alloy.

### Manufacturing Method

A method of manufacturing the soft magnetic alloy of the present embodiment is described below. First, a soft magnetic alloy ribbon is manufactured.

Methods of manufacturing the soft magnetic alloy ribbon of the present embodiment are not limited. In the present embodiment, the soft magnetic alloy ribbon is manufactured using, for example, a single-roll method. The ribbon may be a continuous ribbon.

In the single-roll method, first, pure raw materials of the elements other than oxygen contained in the soft magnetic alloy ribbon eventually obtained are prepared and are weighed so as to provide a composition same as that of the soft magnetic alloy ribbon eventually obtained except for oxygen. The pure raw materials of the elements are melted and are mixed to provide a master alloy. Any method of melting the pure raw materials may be used. Such methods include melting the pure raw materials using a high-frequency heating after a chamber is vacuumed.

Then, the prepared master alloy is heated and melted to provide molten metal. The temperature of the molten metal is not limited. The temperature can be, for example, 1100° C. to 1600° C.

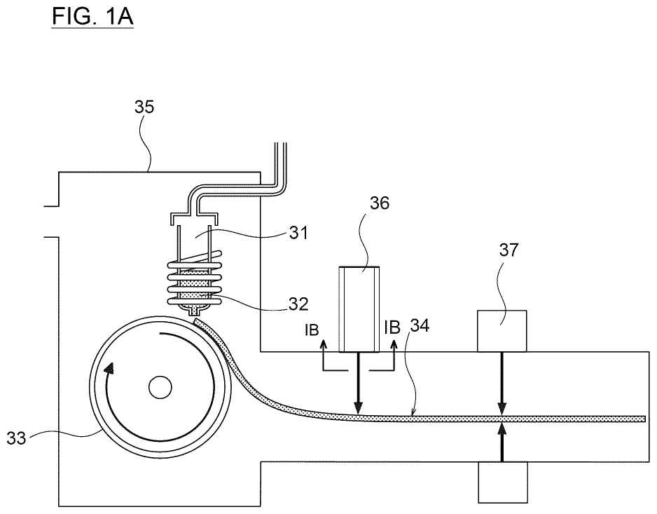

FIG. 1A is a schematic view of a single-roll quenching ribbon manufacturing apparatus used for the single-roll method according to the present embodiment. Inside a chamber 35, the molten metal 32 as a continuous fluid is sprayed to a roll 33 rotating in the direction of an arrow to supply the roll 33 with the molten metal 32 through a nozzle 31 via a slit at the bottom of the nozzle 31. This quenches the molten metal 32 and makes a ribbon 34 stretch uniformly in the rotating direction of the roll 33.

To this ribbon, water is sprayed from a quenching nozzle 36 to provide the ribbon with a water film. This water film quenches the ribbon to provide the soft magnetic alloy ribbon.

In the present embodiment, material of the roll 33 is, for example, Cu. The atmosphere inside the chamber 35 is not limited. Particularly suitable for mass production is an air atmosphere.

A spray port 36a of the quenching nozzle 36 may have any shape or dimensions. The shape can be, other than the rectangular shape shown in FIG. 1B, a circular shape, an oval shape, a quadrilateral shape, etc. The shape preferably has a width or a diameter (containing a major axis) that is equivalent to or larger than the width of the ribbon. It is desirable that the width of the ribbon in its entirety should be quenched with water.

The pressure of the sprayed water is not limited provided that the ribbon can be quenched. However, too high a pressure pulverizes the ribbon and causes it not to be a continuum. Thus, the water pressure is preferably 100 kPa or less, 50 kPa or less, or 10 kPa or less.

The temperature of the sprayed water is not limited provided that the ribbon can be quenched. The temperature is, for example, preferably 10° C. to 80° C.

The thicker the water film, the easier it is to provide the soft magnetic metal alloy ribbon with a higher Mn concentration at a surface of the soft magnetic metal alloy ribbon.

Because the quenched ribbon has the sprayed quenching water remain at the surface, a mechanism for removing the water may be provided. The mechanism is not limited. For example, a gas may be sprayed from a gas spraying mechanism 37 immediately after the ribbon is quenched to separate the ribbon from water. This gas is not limited. Examples of such gases include a N₂ gas and an Ar gas.

The soft magnetic alloy ribbon 34 manufactured using the above method may include crystals with a grain size of above 50 nm but preferably includes no such crystals. The soft magnetic alloy ribbon 34 may have an amorphous structure, or crystals with a grain size of 50 nm or less may be present in an amorphous solid (e.g., a nano-hetero structure). The larger the crystal sizes, the higher the coercivity tends to be. The soft magnetic alloy ribbon 34 may include initial fine crystals. The initial fine crystals mean crystals included in an alloy prior to a nanocrystallization treatment. The initial fine crystals have an average grain size of preferably 0.3 to 10 nm.

Methods of checking whether the soft magnetic alloy ribbon 34 includes crystals with a grain size of above 50 nm are not limited. The presence or absence of such crystals with a grain size of above 50 nm can be checked using, for example, a normal X-ray diffraction measurement. Alternatively, a transmission electron microscope may be used for direct observation.

Methods of checking the presence or absence of the above fine crystals and methods of observing the average grain size are not limited. They can be checked using, for example, a selected area electron diffraction image, a nano beam diffraction image, a bright field image, or a high resolution image, obtained with a transmission electron microscope, of a sample thinned with ion milling. In a situation where the selected area electron diffraction image or the nano beam diffraction image is used, a ring-shaped diffraction pattern is formed for an amorphous structure whereas diffraction spots attributed to a crystal structure are formed for a structure other than the amorphous structure. In a situation where the bright field image or the high resolution image is used, the presence or absence of the fine crystals and the average grain size can be checked through visual observation at a magnification of 1.00×10⁵ to 3.00×10⁵.

In a situation where the X-ray diffraction measurement is used, the amorphous ratio X is calculated with Formula 1 below. An amorphous ratio X of 85% or more can determine that the ribbon is amorphous.

$$X = 100 - ( Ic / ( Ic + I a ) \times 1 \; 00 ) \qquad Formula 1$$

Ic: Crystal scattering integrated intensity
Ia: Amorphous scattering integrated intensity

The amorphous ratio X is calculated as follows. An X-ray crystal structure analysis of the soft magnetic metal alloy ribbon using XRD is performed. In the analysis, phases are identified, and peaks (Ic: crystal scattering integrated intensity, Ia: amorphous scattering integrated intensity) of crystallized Fe or a crystallized compound are read. From the intensities of these peaks, the crystallization ratio is determined, and the amorphous ratio X is calculated using Formula 1 above. A method of calculation is more specifically described below.

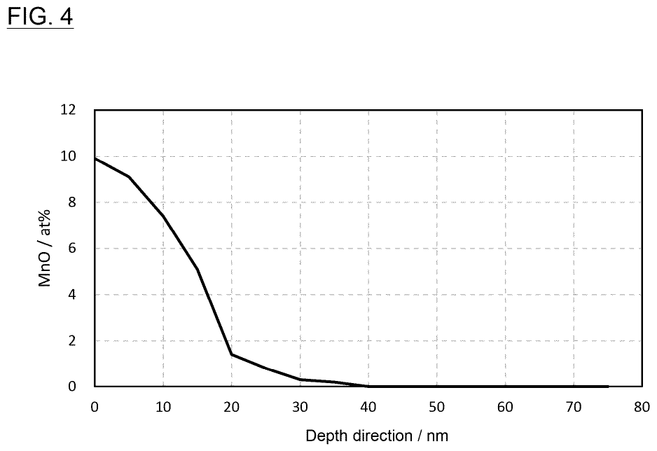

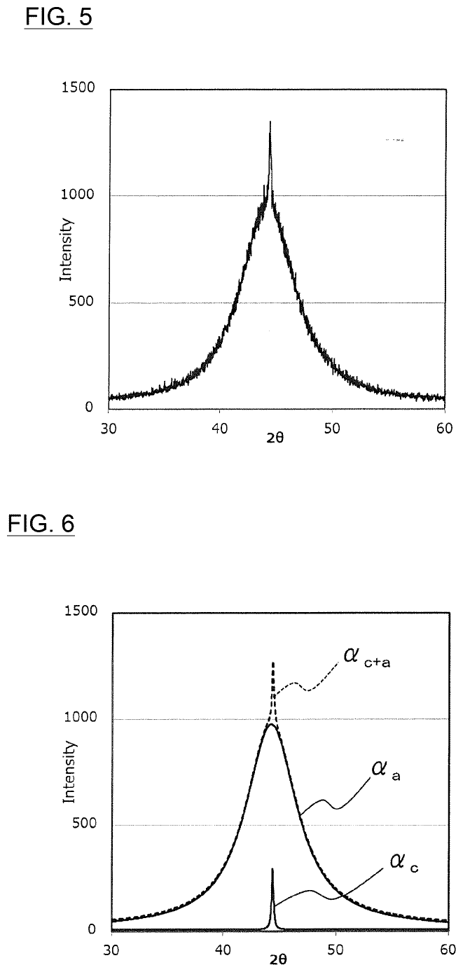

The X-ray crystal structure analysis of the soft magnetic metal alloy ribbon according to the present embodiment is performed using XRD to generate a chart like FIG. 5. Then, profile fitting is performed to this chart using a Lorentzian function shown below as Formula 2 to generate a crystal component pattern α_{c} showing the crystal scattering integrated intensity, an amorphous component pattern αₐ showing the amorphous scattering integrated intensity, and a pattern α_{c+a} showing a combination of these patterns, as shown in FIG. 6. From the patterns of the crystal scattering integrated intensity and the amorphous scattering integrated intensity, the amorphous ratio X is calculated using Formula 1 shown above. Note that the range of measurement is within a diffraction angle of 2θ=30° to 60°, in which a halo derived from amorphousness can be confirmed. In this range, the difference between the experimental integrated intensities measured using XRD and the integrated intensities calculated using the Lorentzian function is 1% or less.

$$\begin{matrix}[ Mathematical 1 ] & \\ f ( x ) = \frac{h}{1 + \frac{{( x - u )}^{2}}{{w}^{2}}} + b & Formula 2\end{matrix}$$

h: Peak height
u: Peak location
w: Full width at half maximum
b: Background height

Whether an amorphous solid includes initial fine crystals is checked with a transmission electron microscope. When the amorphous ratio X is less than 85% and the average crystal grain size is 50 nm or less, the ribbon can be deemed nanocrystalline. When the amorphous ratio X is less than 85% and the average crystal grain size exceeds 50 nm, the ribbon can be deemed crystalline.

In the present embodiment, the alloy ribbon then undergoes a crystallization heat treatment for depositing nanocrystals, particularly Fe based nanocrystals; however, the crystallization heat treatment is not necessarily performed. Fe based nanocrystals are crystals with a nanoscale crystal grain size and a body-centered cubic (bcc) Fe crystal structure. In the present embodiment, Fe based nanocrystals with an average grain size of 5 to 50 nm may be deposited. A soft magnetic alloy with such Fe based nanocrystals deposited tends to have high saturation magnetic flux density and low coercivity.

Conditions of the heat treatment for depositing nanocrystals, particularly Fe based nanocrystals, are not limited provided that oxidation of a surface of the soft magnetic alloy ribbon 34 does not excessively proceed. To maintain the surface state of the soft magnetic alloy, the heat treatment atmosphere is preferably, for example, an inert atmosphere (e.g., an Ar gas) or a vacuum atmosphere. Preferable heat treatment temperature conditions depend on the composition of the soft magnetic alloy ribbon 34. Normally, the preferable heat treatment temperature (crystallization heat treatment temperature) is about 400° C. to 700° C., and the preferable heat treatment time is about 0.5 to 10 hours. However, depending on the composition, the preferable heat treatment temperature and the preferable heat treatment time may fall outside the above ranges.

Performing the heat treatment in an inert atmosphere or a vacuum atmosphere deposits Fe based nanocrystals while the surface state is maintained. Deposition of the Fe based nanocrystals enables the soft magnetic alloy ribbon to easily have good soft magnetic properties.

The soft magnetic alloy ribbon of the present embodiment may have any thickness. The thickness may be, for example, 1 to 100 μm. The soft magnetic alloy ribbon of the present embodiment preferably includes a region containing a Mn oxide (preferably MnO) at or within 100 nm from a surface of the soft magnetic alloy ribbon. To check whether the Mn oxide is present at or within 100 nm from the surface, for example, a chemical-bonding state analysis and a composition analysis with XPS are performed for the surface of the ribbon. Then, the ribbon is etched from the surface in the thickness direction to perform the analysis with XPS again. This can measure the depth of the region containing MnO (MnO-present region) from the surface of the ribbon. The composition analysis of the surface of the ribbon may be performed for one side of the ribbon or for both sides of the ribbon. For the composition analysis, an ICP analysis or an oxygen/nitrogen analysis may be used, or SEM-EDS or an EPMA may be used.

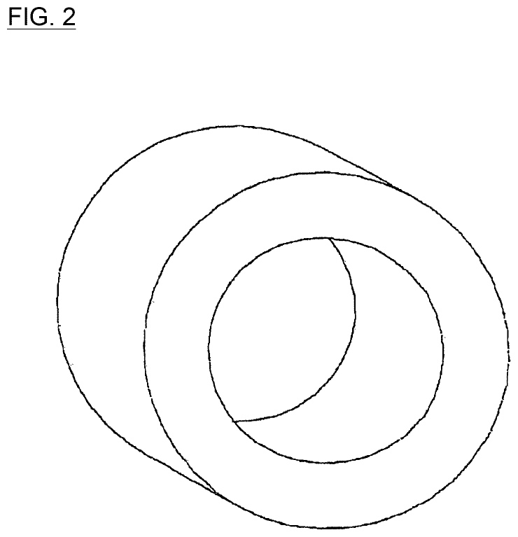

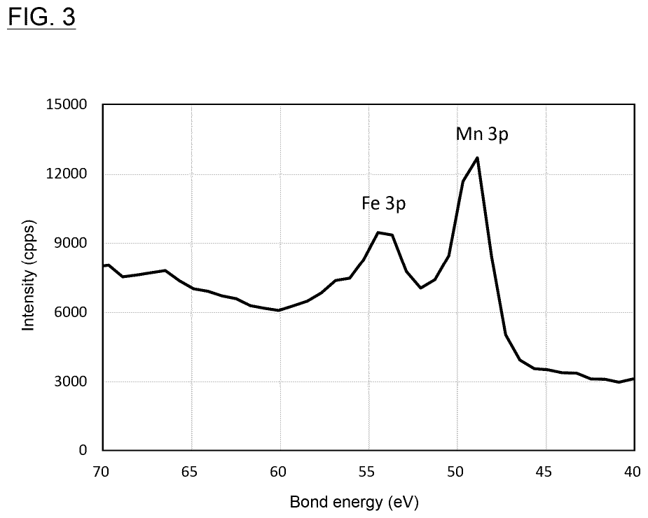

For example, FIG. 3 shows results of the chemical-bonding state analysis with XPS. As shown in FIG. 3, a MnO peak is observed. Then, repeating the composition analysis in the thickness direction for a predetermined depth enables the depth (width) of the MnO-present region to be measured. At this time, a depth at which a Mn concentration of 0.3 at % or more is maintained from the surface can be found as the MnO-present region. As shown in, for example, FIG. 4, the Mn concentration falls below 0.3 at % as the distance from the surface exceeds a predetermined value. This boundary can be defined as the depth of the MnO-present region. The depth of the MnO-present region is not limited. The depth is preferably 100 nm or less or is preferably 90 nm or less, 5 to 100 nm, or 5 to 90 nm from the surface.

In the present embodiment, the soft magnetic alloy ribbon 34 including an amorphous solid or nanocrystals may be pulverized with a pulverization apparatus. Any pulverization apparatus may be used. The pulverization apparatus includes, for example, a pair of pulverization rollers having circumferential surfaces with rough surfaces for crushing. The rough surfaces for crushing can be formed through, for example, knurling of the circumferential surfaces of the rollers.

These rollers can rotate in opposite directions, sandwich the soft magnetic alloy ribbon in a single layer or multiple layers from both sides, and crush the ribbon to manufacture particles constituting a soft magnetic powder.

The particles provided by pulverization through the rollers may further be pulverized with another pulverization apparatus or may be classified with a classification apparatus. Other pulverization apparatuses include, for example, a ball mill, FACULTY, and a jet mill.

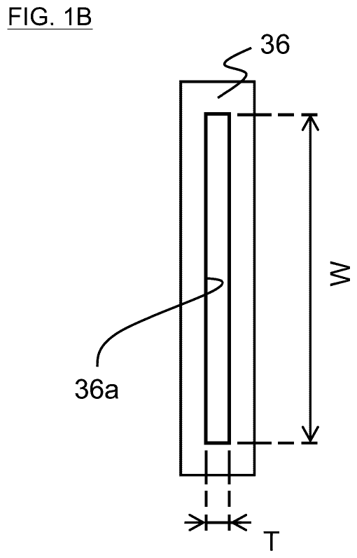

Uses of the soft magnetic alloy according to the above embodiment are not limited. The soft magnetic alloy according to the embodiment may be used alone or in combination with other soft magnetic alloys. For example, a toroidal magnetic core shown in FIG. 2 may be manufactured with stacked soft magnetic alloy ribbons, with the soft magnetic alloy powder and a resin molded together, or with a wound soft magnetic alloy ribbon. Alternatively, a magnetic core in another shape or a magnetic device may be manufactured in a similar manner. The magnetic core may have a wire wound to be used as an electronic device, such as an inductor (in particular, a power device such as a power inductor) or a transformer.

An electronic device (e.g., an inductor) is incorporated in electronic equipment (e.g., a mobile phone and a computer) for use. Magnetic devices other than magnetic cores include a thin film inductor, a magnetic head, and a magnetic shielding sheet. They are incorporated in electronic equipment for use.

### EXAMPLES

Hereinafter, the present invention is described based on more detailed examples. However, the present invention is not limited to these examples.

### Experiment 1a

Raw materials were weighed to provide an alloy composition shown in Table 1 and were melted using high-frequency heating to prepare a master alloy. Then, the prepared master alloy was heated and melted to provide, using an apparatus shown in FIG. 1A or the like, molten metal having a temperature of 1100° C. to 1600° C. according to the alloy composition. Then, in an air atmosphere, the metal was sprayed to a roll 33 using a single-roll method to provide a ribbon.

In Experiment 1a, M was Nb. The material of the roll 33 was Cu. A quenching nozzle had a nozzle opening having a rectangular shape with a long side length W of 75 mm and a short side length T of 1.0 mm shown in FIG. 1B. The water pressure was 1 kPa. The water temperature was 20° C. That is, the soft magnetic ribbon was manufactured under conditions shown in Table 1. Note that the ribbon had a width of 50 mm, which was not larger than the long side (75 mm) of the nozzle opening of the quenching nozzle, and a thickness of 20 μm. Then, the ribbon went through a crystallization heat treatment in an Ar atmosphere at 600° C. for 60 minutes to provide an alloy ribbon according to Sample No. 8. The composition of the resultant alloy ribbon was found through an ICP analysis, a CS analysis, and an oxygen analysis.

The ribbon went through an X-ray diffraction measurement to calculate the amorphous ratio X. When the amorphous ratio X was 85% or more, the ribbon was deemed amorphous.

Whether initial fine crystals were included in the amorphous solid was checked with a transmission electron microscope. When the amorphous ratio X was less than 85% and the average crystal grain size was 50 nm or less, the ribbon was deemed nanocrystalline. When the amorphous ratio X was less than 85% and the average crystal grain size exceeded 50 nm, the ribbon was deemed crystalline. It was confirmed that the ribbon was composed of nanocrystals.

Then, specific resistance, saturation magnetic flux density, and coercivity of the ribbon were measured. The specific resistance (ρ) was measured through measurement of resistivity with a four point probe method. The saturation magnetic flux density (Bs) was measured with a vibrating sample magnetometer (VSM) at a magnetic field of 1000 kA/m. The coercivity (Hc) was measured with a direct current BH tracer at a magnetic field of 5 kA/m. Table 1 shows the results.

In Table 1, a specific resistance of 75.0 μΩcm or more was deemed good. A saturation magnetic flux density of 1.50 T or more was deemed good. A coercivity of 10 A/m or less was deemed good.

Note that, in all of the following Examples, it was confirmed, through the X-ray diffraction measurement and observation with the transmission electron microscope, that the ribbon included Fe based nanocrystals with an average grain size of 5 to 50 nm and a bcc crystal structure, unless otherwise specified.

A surface of the ribbon went through a chemical-bonding state analysis with XPS. FIG. 3 shows results of the chemical-bonding state analysis with XPS. As shown in FIG. 3, a MnO peak was observed. Then, the ribbon was etched from the surface in the thickness direction to perform a composition analysis with XPS again. The composition analysis was repeated in the thickness direction for 75 nm.

A depth at which a Mn concentration of 0.3 at % or more was maintained from the surface was found as a MnO-present region. FIG. 4 and Table 2 show the results. As shown in Table 2 and FIG. 4, the Mn concentration fell below 0.3 at % as the distance from the surface exceeded a predetermined value. This boundary was found as the depth (“MnO depth” in the table) of the MnO-present region.

As for Sample Nos. 2 to 13 of Table 1, similar measurements were carried out as in Sample No. 8 except that the short side length T of the spray port of the quenching nozzle was changed. Tables 1 and 2 show the results.

### Experiment 1b

An alloy ribbon according to Sample No. 1 was prepared as in Sample No. 2 except that the ribbon was prepared with the single-roll method in a vacuum atmosphere under 1.0×10⁻³ Pa or less and that quenching with quenching water was not performed. The resultant ribbon was evaluated as in Experiment 1a.

Table 1 shows the results. As shown in Table 1, no MnO peak was observed in the chemical-bonding state analysis with XPS, but the presence of Mn was confirmed in the composition analysis with ICP. Because no MnO peak was observed, the MnO depth was not measured. This is indicated by “-” in the table.

### Experiment 1c

An alloy ribbon according to Sample No. 14 was prepared as in Sample No. 2 except that the condition of quenching with quenching water was changed to the value shown in Table 1. The resultant ribbon was evaluated as in Experiment 1a. Table 1 shows the results.

TABLE 1

| | | | Quenching | | | | | | |
|---|---|---|---|---|---|---|---|---|---|
| | | | nozzle | | | | | | |
| | Example/ | Single-roll | Short side | | | | | | |
| Sample | Comparative | method | length | | M(═Nb) | B | P | Si | C |
| No. | Example | atmosphere | (mm) | Fe | a | b | c | d | e |
| 1 | Comparative Example | Vacuum | — | 0.805 | 0.050 | 0.080 | 0.050 | 0.000 | 0.005 |
| 2 | Example | Air | 0.1 | 0.805 | 0.050 | 0.080 | 0.050 | 0.000 | 0.005 |
| 3 | Example | Air | 0.2 | 0.805 | 0.050 | 0.080 | 0.050 | 0.000 | 0.005 |
| 4 | Example | Air | 0.3 | 0.805 | 0.050 | 0.080 | 0.050 | 0.000 | 0.005 |
| 5 | Example | Air | 0.5 | 0.805 | 0.050 | 0.080 | 0.050 | 0.000 | 0.005 |
| 6 | Example | Air | 0.6 | 0.804 | 0.050 | 0.080 | 0.050 | 0.000 | 0.005 |
| 7 | Example | Air | 0.8 | 0.804 | 0.050 | 0.080 | 0.050 | 0.000 | 0.005 |
| 8 | Example | Air | 1.0 | 0.804 | 0.050 | 0.080 | 0.050 | 0.000 | 0.005 |
| 9 | Example | Air | 1.5 | 0.802 | 0.050 | 0.080 | 0.050 | 0.000 | 0.005 |
| 10 | Example | Air | 2.0 | 0.800 | 0.050 | 0.080 | 0.050 | 0.000 | 0.005 |
| 11 | Example | Air | 2.5 | 0.798 | 0.050 | 0.080 | 0.050 | 0.000 | 0.005 |
| 12 | Example | Air | 3.0 | 0.795 | 0.050 | 0.080 | 0.050 | 0.000 | 0.005 |
| 13 | Example | Air | 3.2 | 0.793 | 0.050 | 0.080 | 0.050 | 0.000 | 0.005 |
| 14 | Comparative Example | Air | 3.3 | 0.792 | 0.050 | 0.080 | 0.050 | 0.000 | 0.005 |

| | | | | Specific | | | | MnO |
|---|---|---|---|---|---|---|---|---|
| Sample | Mn | O | | resistance | Hc | Bs | Mn | depth |
| No. | f | h | f/h | (μΩcm) | (A/m) | (T) | state | (nm) |
| 1 | 0.010 | 0.00008 | 125.00 | 70.3 | 3.6 | 1.59 | Mn | — |
| 2 | 0.010 | 0.00010 | 100.00 | 75.2 | 3.4 | 1.59 | Mn | — |
| 3 | 0.010 | 0.00020 | 50.00 | 75.8 | 3.4 | 1.59 | Mn | — |
| 4 | 0.010 | 0.00030 | 33.33 | 80.2 | 3.5 | 1.59 | Mn—O | 5 |
| 5 | 0.010 | 0.00050 | 20.00 | 81.3 | 3.7 | 1.58 | Mn—O | 10 |
| 6 | 0.010 | 0.00070 | 14.29 | 81.5 | 3.6 | 1.58 | Mn—O | 20 |
| 7 | 0.010 | 0.00100 | 10.00 | 81.8 | 3.4 | 1.58 | Mn—O | 25 |
| 8 | 0.010 | 0.00150 | 6.67 | 82.2 | 3.6 | 1.57 | Mn—O | 40 |
| 9 | 0.010 | 0.00300 | 3.33 | 86.4 | 3.8 | 1.56 | Mn—O | 60 |
| 10 | 0.010 | 0.00500 | 2.00 | 89.3 | 4.2 | 1.54 | Mn—O | 70 |
| 11 | 0.010 | 0.00700 | 1.43 | 90.3 | 4.2 | 1.53 | Mn—O | 80 |
| 12 | 0.010 | 0.01000 | 1.00 | 92.8 | 4.3 | 1.52 | Mn—O | 90 |
| 13 | 0.010 | 0.01200 | 0.83 | 94.5 | 4.7 | 1.51 | Mn—O | 100 |
| 14 | 0.010 | 0.01300 | 0.77 | 98.0 | 5.3 | 1.46 | Mn—O | 105 |

TABLE 2

| | Example/ | | | | | | | | | | | | |
|---|---|---|---|---|---|---|---|---|---|---|---|---|---|
| Sample | Comparative | MnO concentration [at %] | | | | | | | | | | | |
| No. | Example | 0 nm | 5 nm | 10 nm | 15 nm | 20 nm | 25 nm | 30 nm | 35 nm | 40 nm | 45 nm | 50 nm | 55 nm |
| 3 | Example | — | — | — | — | — | — | — | — | — | — | — | — |
| 4 | Example | 9.3 | 3.1 | 0.0 | 0.0 | 0.0 | 0.0 | 0.0 | 0.0 | 0.0 | 0.0 | 0.0 | 0.0 |
| 5 | Example | 9.9 | 3.7 | 2.0 | 0.0 | 0.0 | 0.0 | 0.0 | 0.0 | 0.0 | 0.0 | 0.0 | 0.0 |
| 6 | Example | 10.3 | 8.2 | 5.1 | 3.2 | 0.8 | 0.0 | 0.0 | 0.0 | 0.0 | 0.0 | 0.0 | 0.0 |
| 7 | Example | 10.9 | 8.8 | 6.9 | 5.1 | 2.1 | 0.4 | 0.0 | 0.0 | 0.0 | 0.0 | 0.0 | 0.0 |
| 8 | Example | 11.4 | 10.1 | 8.1 | 6.2 | 5.0 | 3.3 | 1.9 | 0.8 | 0.3 | 0.0 | 0.0 | 0.0 |
| 9 | Example | 11.6 | 10.6 | 9.4 | 8.1 | 6.3 | 5.0 | 3.2 | 2.5 | 1.9 | 1.2 | 0.9 | 0.7 |
| 10 | Example | 11.9 | 11.2 | 10.6 | 9.3 | 7.1 | 5.9 | 4.5 | 3.6 | 2.5 | 1.8 | 1.3 | 1.1 |
| 11 | Example | 12.1 | 11.9 | 11.2 | 10.5 | 9.4 | 7.0 | 6.1 | 4.8 | 3.9 | 3.1 | 2.4 | 2.0 |
| 12 | Example | 12.6 | 12.3 | 11.8 | 11.3 | 10.9 | 10.0 | 9.3 | 8.4 | 7.2 | 6.2 | 5.0 | 4.5 |
| 13 | Example | 13.5 | 13.2 | 12.9 | 12.3 | 11.9 | 11.5 | 11.0 | 10.4 | 9.7 | 8.9 | 8.2 | 7.5 |
| 14 | Comparative Example | 14.0 | 13.8 | 13.6 | 13.2 | 12.7 | 12.4 | 12.0 | 11.6 | 11.1 | 10.6 | 10.2 | 9.6 |

| Sample | MnO concentration [at %] | | | | | | | | | | | | |
|---|---|---|---|---|---|---|---|---|---|---|---|---|---|
| No. | 60 nm | 65 nm | 70 nm | 75 nm | 80 nm | 85 nm | 90 nm | 95 nm | 100 nm | 105 nm | 110 nm | 115 nm | 120 nm |
| 3 | — | — | — | — | — | — | — | — | — | — | — | — | — |
| 4 | 0.0 | 0.0 | 0.0 | 0.0 | 0.0 | 0.0 | 0.0 | 0.0 | 0.0 | 0.0 | 0.0 | 0.0 | 0.0 |
| 5 | 0.0 | 0.0 | 0.0 | 0.0 | 0.0 | 0.0 | 0.0 | 0.0 | 0.0 | 0.0 | 0.0 | 0.0 | 0.0 |
| 6 | 0.0 | 0.0 | 0.0 | 0.0 | 0.0 | 0.0 | 0.0 | 0.0 | 0.0 | 0.0 | 0.0 | 0.0 | 0.0 |
| 7 | 0.0 | 0.0 | 0.0 | 0.0 | 0.0 | 0.0 | 0.0 | 0.0 | 0.0 | 0.0 | 0.0 | 0.0 | 0.0 |
| 8 | 0.0 | 0.0 | 0.0 | 0.0 | 0.0 | 0.0 | 0.0 | 0.0 | 0.0 | 0.0 | 0.0 | 0.0 | 0.0 |
| 9 | 0.5 | 0.0 | 0.0 | 0.0 | 0.0 | 0.0 | 0.0 | 0.0 | 0.0 | 0.0 | 0.0 | 0.0 | 0.0 |
| 10 | 0.8 | 0.5 | 0.3 | 0.0 | 0.0 | 0.0 | 0.0 | 0.0 | 0.0 | 0.0 | 0.0 | 0.0 | 0.0 |
| 11 | 1.5 | 1.0 | 0.8 | 0.5 | 0.4 | 0.0 | 0.0 | 0.0 | 0.0 | 0.0 | 0.0 | 0.0 | 0.0 |
| 12 | 3.6 | 3.1 | 2.7 | 2.1 | 1.6 | 1.3 | 0.6 | 0.1 | 0.0 | 0.0 | 0.0 | 0.0 | 0.0 |
| 13 | 6.5 | 5.6 | 4.8 | 3.9 | 3.1 | 2.7 | 2.0 | 1.5 | 0.6 | 0.0 | 0.0 | 0.0 | 0.0 |
| 14 | 8.8 | 8.0 | 7.1 | 6.2 | 5.5 | 4.9 | 4.1 | 3.6 | 2.5 | 1.5 | 0.0 | 0.0 | 0.0 |

### Evaluation 1

Table 1 revealed that each Example having component contents within predetermined ranges had high specific resistance, low coercivity, and high saturation magnetic flux density compatible with each other. In contrast, Sample No. 1 with a low O content (h) had low specific resistance. A Comparative Example with a high O content (h) had high coercivity and low saturation magnetic flux density.

It was found that, in the ribbons of Sample Nos. 1 and 2, Mn was not present as an oxide and was present as a simple substance of Mn at least at a surface of the ribbons. It was also found that, as the O content (h) increased, the MnO depth tended to increase.

### Experiment 2a

Alloy ribbons according to Sample Nos. 15 to 21 were prepared as in Sample No. 4 except that the Mn content (f) was changed so as to provide the Mn content and the O content shown in Table 3 and that the short side length of the quenching nozzle was controlled to control the MnO depth. The resultant ribbons were evaluated as in Sample No. 4. Table 3 shows the results.

### Experiment 2b

Alloy ribbons according to Sample Nos. 22 to 28 were prepared as in Sample No. 5 except that the Mn content (f) was changed so as to provide the Mn content and the O content shown in Table 3 and that the short side length of the quenching nozzle was controlled to control the MnO depth. The resultant ribbons were evaluated as in Sample No. 5. Table 3 shows the results.

### Experiment 2c

Alloy ribbons according to Sample Nos. 29 to 35 were prepared as in Sample No. 6 except that the Mn content (f) was changed so as to provide the Mn content and the O content shown in Table 3 and that the short side length of the quenching nozzle was controlled to control the MnO depth. The resultant ribbons were evaluated as in Sample No. 6. Table 3 shows the results.

### Experiment 2d

Alloy ribbons according to Sample Nos. 36 to 42 were prepared as in Sample No. 8 except that the Mn content (f) was changed so as to provide the Mn content and the O content shown in Table 3 and that the short side length of the quenching nozzle was controlled to control the MnO depth. The resultant ribbons were evaluated as in Sample No. 8. Table 3 shows the results.

### Experiment 2e

Alloy ribbons according to Sample Nos. 43 to 48 were prepared as in Sample No. 19 except that the Mn content (f) was changed so as to provide the Mn content and the O content shown in Table 3 and that the short side length of the quenching nozzle was controlled to control the MnO depth. The resultant ribbons were evaluated as in Sample No. 19. Table 3 shows the results.

### Experiment 2f

Alloy ribbons according to Sample Nos. 49 to 53 were prepared as in Sample No. 13 except that the Mn content (f) was changed so as to provide the Mn content and the O content shown in Table 3 and that the short side length of the quenching nozzle was controlled to control the MnO depth. The resultant ribbons were evaluated as in Sample No. 13. Table 3 shows the results.

TABLE 3

| | Example/ | | | | | | | | | | MnO | Specific | | |
|---|---|---|---|---|---|---|---|---|---|---|---|---|---|---|
| Sample | Comparative | | M(═Nb) | B | P | Si | C | Mn | O | | depth | resistance | Hc | Bs |
| No. | Example | Fe | a | b | c | d | e | f | h | f/h | (nm) | (μΩcm) | (A/m) | (T) |
| 15 | Comparative Example | 0.815 | 0.050 | 0.080 | 0.050 | 0.000 | 0.005 | 0.0000 | 0.00030 | 0.00 | 0 | 72.5 | 5.6 | 1.61 |
| 16 | Example | 0.815 | 0.050 | 0.080 | 0.050 | 0.000 | 0.005 | 0.0001 | 0.00030 | 0.33 | 0 | 75.2 | 4.9 | 1.61 |
| 17 | Example | 0.814 | 0.050 | 0.080 | 0.050 | 0.000 | 0.005 | 0.0005 | 0.00030 | 1.67 | 5 | 75.5 | 4.1 | 1.61 |
| 18 | Example | 0.814 | 0.050 | 0.080 | 0.050 | 0.000 | 0.005 | 0.0010 | 0.00030 | 3.33 | 5 | 75.6 | 3.9 | 1.61 |
| 19 | Example | 0.810 | 0.050 | 0.080 | 0.050 | 0.000 | 0.005 | 0.0050 | 0.00030 | 16.67 | 5 | 75.9 | 3.6 | 1.60 |
| 4 | Example | 0.805 | 0.050 | 0.080 | 0.050 | 0.000 | 0.005 | 0.0100 | 0.00030 | 33.33 | 5 | 80.2 | 3.5 | 1.59 |
| 20 | Example | 0.795 | 0.050 | 0.080 | 0.050 | 0.000 | 0.005 | 0.0200 | 0.00030 | 66.67 | 10 | 83.9 | 3.5 | 1.55 |
| 21 | Comparative Example | 0.794 | 0.050 | 0.080 | 0.050 | 0.000 | 0.005 | 0.0210 | 0.00030 | 70.00 | 10 | 87.6 | 3.5 | 1.49 |
| 22 | Comparative Example | 0.815 | 0.050 | 0.080 | 0.050 | 0.000 | 0.005 | 0.0000 | 0.00050 | 0.00 | 0 | 73.0 | 6.0 | 1.61 |
| 23 | Example | 0.814 | 0.050 | 0.080 | 0.050 | 0.000 | 0.005 | 0.0001 | 0.00050 | 0.20 | 0 | 75.3 | 5.1 | 1.61 |
| 24 | Example | 0.814 | 0.050 | 0.080 | 0.050 | 0.000 | 0.005 | 0.0005 | 0.00050 | 1.00 | 5 | 75.6 | 4.0 | 1.61 |
| 25 | Example | 0.814 | 0.050 | 0.080 | 0.050 | 0.000 | 0.005 | 0.0010 | 0.00050 | 2.00 | 5 | 75.9 | 3.9 | 1.61 |
| 26 | Example | 0.810 | 0.050 | 0.080 | 0.050 | 0.000 | 0.005 | 0.0050 | 0.00050 | 10.00 | 5 | 76.2 | 3.6 | 1.60 |
| 5 | Example | 0.805 | 0.050 | 0.080 | 0.050 | 0.000 | 0.005 | 0.0100 | 0.00050 | 20.00 | 10 | 81.3 | 3.7 | 1.58 |
| 27 | Example | 0.795 | 0.050 | 0.080 | 0.050 | 0.000 | 0.005 | 0.0200 | 0.00050 | 40.00 | 10 | 84.4 | 3.5 | 1.54 |
| 28 | Comparative Example | 0.794 | 0.050 | 0.080 | 0.050 | 0.000 | 0.005 | 0.0210 | 0.00050 | 42.00 | 15 | 88.1 | 3.5 | 1.49 |
| 29 | Comparative Example | 0.814 | 0.050 | 0.080 | 0.050 | 0.000 | 0.005 | 0.0000 | 0.00070 | 0.00 | 0 | 73.4 | 7.3 | 1.61 |
| 30 | Example | 0.814 | 0.050 | 0.080 | 0.050 | 0.000 | 0.005 | 0.0001 | 0.00070 | 0.14 | 5 | 75.3 | 6.2 | 1.61 |
| 31 | Example | 0.814 | 0.050 | 0.080 | 0.050 | 0.000 | 0.005 | 0.0005 | 0.00070 | 0.71 | 10 | 75.7 | 4.4 | 1.60 |
| 32 | Example | 0.813 | 0.050 | 0.080 | 0.050 | 0.000 | 0.005 | 0.0010 | 0.00070 | 1.43 | 15 | 76.0 | 3.9 | 1.60 |
| 33 | Example | 0.809 | 0.050 | 0.080 | 0.050 | 0.000 | 0.005 | 0.0050 | 0.00070 | 7.14 | 15 | 76.5 | 3.7 | 1.59 |
| 6 | Example | 0.804 | 0.050 | 0.080 | 0.050 | 0.000 | 0.005 | 0.0100 | 0.00070 | 14.29 | 20 | 81.5 | 3.6 | 1.58 |
| 34 | Example | 0.794 | 0.050 | 0.080 | 0.050 | 0.000 | 0.005 | 0.0200 | 0.00070 | 28.57 | 30 | 84.8 | 3.6 | 1.55 |
| 35 | Comparative Example | 0.793 | 0.050 | 0.080 | 0.050 | 0.000 | 0.005 | 0.0210 | 0.00070 | 30.00 | 35 | 88.7 | 3.5 | 1.49 |
| 36 | Comparative Example | 0.814 | 0.050 | 0.080 | 0.050 | 0.000 | 0.005 | 0.0000 | 0.00150 | 0.00 | 0 | 74.0 | 8.5 | 1.62 |
| 37 | Example | 0.813 | 0.050 | 0.080 | 0.050 | 0.000 | 0.005 | 0.0001 | 0.00150 | 0.07 | 5 | 75.4 | 7.5 | 1.61 |
| 38 | Example | 0.813 | 0.050 | 0.080 | 0.050 | 0.000 | 0.005 | 0.0005 | 0.00150 | 0.33 | 10 | 75.8 | 4.8 | 1.61 |
| 39 | Example | 0.813 | 0.050 | 0.080 | 0.050 | 0.000 | 0.005 | 0.0010 | 0.00150 | 0.67 | 20 | 76.2 | 4.6 | 1.60 |
| 40 | Example | 0.809 | 0.050 | 0.080 | 0.050 | 0.000 | 0.005 | 0.0050 | 0.00150 | 3.33 | 25 | 77.2 | 3.9 | 1.59 |
| 8 | Example | 0.804 | 0.050 | 0.080 | 0.050 | 0.000 | 0.005 | 0.0100 | 0.00150 | 6.67 | 40 | 82.2 | 3.6 | 1.57 |
| 41 | Example | 0.794 | 0.050 | 0.080 | 0.050 | 0.000 | 0.005 | 0.0200 | 0.00150 | 13.33 | 50 | 85.3 | 3.6 | 1.56 |
| 42 | Comparative Example | 0.793 | 0.050 | 0.080 | 0.050 | 0.000 | 0.005 | 0.0210 | 0.00150 | 14.00 | 50 | 89.0 | 3.6 | 1.48 |
| 43 | Comparative Example | 0.805 | 0.050 | 0.080 | 0.050 | 0.000 | 0.005 | 0.0001 | 0.01000 | 0.01 | 20 | 80.0 | 15.8 | 1.55 |
| 44 | Example | 0.805 | 0.050 | 0.080 | 0.050 | 0.000 | 0.005 | 0.0005 | 0.01000 | 0.05 | 30 | 81.2 | 7.5 | 1.55 |
| 45 | Example | 0.804 | 0.050 | 0.080 | 0.050 | 0.000 | 0.005 | 0.0010 | 0.01000 | 0.10 | 40 | 81.8 | 6.9 | 1.55 |
| 46 | Example | 0.800 | 0.050 | 0.080 | 0.050 | 0.000 | 0.005 | 0.0050 | 0.01000 | 0.50 | 50 | 83.0 | 5.0 | 1.54 |
| 19 | Example | 0.795 | 0.050 | 0.080 | 0.050 | 0.000 | 0.005 | 0.0100 | 0.01000 | 1.00 | 90 | 92.8 | 4.3 | 1.52 |
| 47 | Example | 0.785 | 0.050 | 0.080 | 0.050 | 0.000 | 0.005 | 0.0200 | 0.01000 | 2.00 | 95 | 94.5 | 4.1 | 1.51 |
| 48 | Comparative Example | 0.784 | 0.050 | 0.080 | 0.050 | 0.000 | 0.005 | 0.0210 | 0.01000 | 2.10 | 100 | 101.0 | 3.9 | 1.48 |
| 49 | Comparative Example | 0.803 | 0.050 | 0.080 | 0.050 | 0.000 | 0.005 | 0.0005 | 0.01200 | 0.04 | 40 | 81.5 | 11.7 | 1.53 |
| 50 | Example | 0.802 | 0.050 | 0.080 | 0.050 | 0.000 | 0.005 | 0.0010 | 0.01200 | 0.08 | 55 | 82.0 | 10.0 | 1.53 |
| 51 | Example | 0.798 | 0.050 | 0.080 | 0.050 | 0.000 | 0.005 | 0.0050 | 0.01200 | 0.42 | 80 | 88.0 | 6.5 | 1.52 |
| 13 | Example | 0.793 | 0.050 | 0.080 | 0.050 | 0.000 | 0.005 | 0.0100 | 0.01200 | 0.83 | 100 | 94.5 | 4.7 | 1.51 |
| 52 | Example | 0.783 | 0.050 | 0.080 | 0.050 | 0.000 | 0.005 | 0.0200 | 0.01200 | 1.67 | 100 | 96.2 | 4.5 | 1.50 |
| 53 | Comparative Example | 0.782 | 0.050 | 0.080 | 0.050 | 0.000 | 0.005 | 0.0210 | 0.01200 | 1.75 | 105 | 112.0 | 4.4 | 1.46 |

### Evaluation 2

The results shown in Table 3 revealed that, even with varying “f” and “h”, each Example having component contents satisfying a predetermined composition had high specific resistance, low coercivity, and high saturation magnetic flux density compatible with each other. It was also found that the MnO depth was preferably 100 nm or less or 40 nm or less.

### Experiment 3a

Alloy ribbons were prepared as in Sample No. 8 except that components were controlled to provide a composition shown in Table 4A. The ribbons were evaluated as in Sample No. 8. Table 4A shows the results.

TABLE 4A

| | Example/ | | | | | | | | | | Specific | | |
|---|---|---|---|---|---|---|---|---|---|---|---|---|---|
| Sample | Comparative | | M(═Nb) | B | P | Si | C | Mn | O | | resistance | Hc | Bs |
| No. | Example | Fe | a | b | c | d | e | f | h | f/h | (μΩcm) | (A/m) | (T) |
| 54 | Comparative Example | 0.920 | 0.020 | 0.029 | 0.017 | 0.000 | 0.002 | 0.01 | 0.0015 | 6.67 | 72.0 | 9.5 | 1.68 |
| 55 | Example | 0.918 | 0.020 | 0.030 | 0.018 | 0.000 | 0.002 | 0.01 | 0.0015 | 6.67 | 75.1 | 8.9 | 1.67 |
| 56 | Example | 0.870 | 0.032 | 0.051 | 0.032 | 0.000 | 0.003 | 0.01 | 0.0015 | 6.67 | 78.9 | 8.9 | 1.62 |
| 57 | Example | 0.840 | 0.040 | 0.064 | 0.040 | 0.000 | 0.004 | 0.01 | 0.0015 | 6.67 | 80.5 | 5.3 | 1.60 |
| 8 | Example | 0.804 | 0.050 | 0.080 | 0.050 | 0.000 | 0.005 | 0.01 | 0.0015 | 6.67 | 82.2 | 3.6 | 1.57 |
| 58 | Example | 0.790 | 0.054 | 0.086 | 0.054 | 0.000 | 0.005 | 0.01 | 0.0015 | 6.67 | 82.5 | 3.8 | 1.57 |
| 59 | Example | 0.770 | 0.059 | 0.095 | 0.059 | 0.000 | 0.006 | 0.01 | 0.0015 | 6.67 | 82.6 | 4.4 | 1.53 |
| 60 | Example | 0.730 | 0.070 | 0.111 | 0.070 | 0.000 | 0.007 | 0.01 | 0.0015 | 6.67 | 82.3 | 6.7 | 1.50 |
| 61 | Comparative Example | 0.728 | 0.070 | 0.113 | 0.070 | 0.000 | 0.007 | 0.01 | 0.0015 | 6.67 | 83.0 | 8.0 | 1.49 |

### Evaluation 3a

The results shown in Table 4A revealed that, even with varying Fe content, the predetermined composition simultaneously allowed high specific resistance, low coercivity, and high saturation magnetic flux density.

### Experiment 3b

Alloy ribbons were prepared as in Sample No. 8 except that the M (Nb) content (a) was controlled as shown in Table 4B. The ribbons were evaluated as in Sample No. 8. Table 4B shows the results.

TABLE 4B

| | | | | | | | | | | | Specific | | |
|---|---|---|---|---|---|---|---|---|---|---|---|---|---|
| Sample | Example/ | | M(═Nb) | B | P | Si | C | Mn | O | | resistance | Hc | Bs |
| No. | Comparative Example | Fe | a | b | c | d | e | f | h | f/h | (μΩcm) | (A/m) | (T) |
| 62 | Comparative Example | 0.844 | 0.010 | 0.080 | 0.050 | 0.000 | 0.005 | 0.01 | 0.0015 | 6.67 | 81.5 | 631 | 1.64 |
| 63 | Example | 0.834 | 0.020 | 0.080 | 0.050 | 0.000 | 0.005 | 0.01 | 0.0015 | 6.67 | 80.5 | 8.9 | 1.62 |
| 8 | Example | 0.804 | 0.050 | 0.080 | 0.050 | 0.000 | 0.005 | 0.01 | 0.0015 | 6.67 | 82.2 | 3.6 | 1.57 |
| 64 | Example | 0.774 | 0.080 | 0.080 | 0.050 | 0.000 | 0.005 | 0.01 | 0.0015 | 6.67 | 81.9 | 4.1 | 1.52 |
| 65 | Example | 0.754 | 0.100 | 0.080 | 0.050 | 0.000 | 0.005 | 0.01 | 0.0015 | 6.67 | 80.2 | 6.8 | 1.50 |
| 66 | Comparative Example | 0.734 | 0.120 | 0.080 | 0.050 | 0.000 | 0.005 | 0.01 | 0.0015 | 6.67 | 80.9 | 7.4 | 1.46 |

### Evaluation 3b

The results shown in Table 4B revealed that, even with varying M (Nb) content (a), the predetermined composition simultaneously allowed high specific resistance, low coercivity, and high saturation magnetic flux density. In contrast, a Comparative Example with a low M (Nb) content (a) had high coercivity. A Comparative Example with a high “a” had low saturation magnetic flux density Bs and tended to have higher coercivity.

### Experiment 4

Soft magnetic alloy ribbons were prepared as in Sample No. 8 except that the B content (b) was controlled as shown in Table 5. The ribbons were evaluated as in Sample No. 8. Table 5 shows the results.

TABLE 5

| | | | | | | | | | | | Specific | | |
|---|---|---|---|---|---|---|---|---|---|---|---|---|---|
| Sample | Example/ | | M(═Nb) | B | P | Si | C | Mn | O | | resistance | Hc | Bs |
| No. | Comparative Example | Fe | a | b | c | d | e | f | h | f/h | (μΩcm) | (A/m) | (T) |
| 67 | Comparative Example | 0.874 | 0.050 | 0.010 | 0.050 | 0.000 | 0.005 | 0.01 | 0.0015 | 6.67 | 82.0 | 476 | 1.66 |
| 68 | Example | 0.864 | 0.050 | 0.020 | 0.050 | 0.000 | 0.005 | 0.01 | 0.0015 | 6.67 | 80.5 | 7.3 | 1.65 |
| 69 | Example | 0.844 | 0.050 | 0.040 | 0.050 | 0.000 | 0.005 | 0.01 | 0.0015 | 6.67 | 81.0 | 6.4 | 1.62 |
| 8 | Example | 0.804 | 0.050 | 0.080 | 0.050 | 0.000 | 0.005 | 0.01 | 0.0015 | 6.67 | 82.2 | 3.6 | 1.57 |
| 70 | Example | 0.744 | 0.050 | 0.140 | 0.050 | 0.000 | 0.005 | 0.01 | 0.0015 | 6.67 | 81.5 | 5.0 | 1.54 |
| 71 | Example | 0.720 | 0.050 | 0.164 | 0.050 | 0.000 | 0.005 | 0.01 | 0.0015 | 6.67 | 81.9 | 5.3 | 1.53 |
| 72 | Example | 0.704 | 0.050 | 0.180 | 0.050 | 0.000 | 0.005 | 0.01 | 0.0015 | 6.67 | 81.7 | 5.7 | 1.52 |
| 73 | Example | 0.684 | 0.050 | 0.200 | 0.050 | 0.000 | 0.005 | 0.01 | 0.0015 | 6.67 | 80.7 | 6.4 | 1.51 |
| 74 | Comparative Example | 0.664 | 0.050 | 0.220 | 0.050 | 0.000 | 0.005 | 0.01 | 0.0015 | 6.67 | 80.5 | 6.6 | 1.47 |

### Evaluation 4

The results shown in Table 5 revealed that, even with varying “b”, the predetermined composition simultaneously allowed high specific resistance, low coercivity, and high saturation magnetic flux density. A Comparative Example with a low “b” had high coercivity. A Comparative Example with a high “b” had low saturation magnetic flux density Bs and tended to have higher coercivity.

### Experiment 5

Soft magnetic alloy ribbons were prepared as in Sample No. 8 except that the P content (c) was controlled as shown in Table 6. The ribbons were evaluated as in Sample No. 8. Table 6 shows the results.

TABLE 6

| | | | | | | | | | | | Specific | | |
|---|---|---|---|---|---|---|---|---|---|---|---|---|---|
| Sample | Example/ | | M(═Nb) | B | P | Si | C | Mn | O | | resistance | Hc | Bs |
| No. | Comparative Example | Fe | a | b | c | d | e | f | h | f/h | (μΩcm) | (A/m) | (T) |
| 75 | Example | 0.854 | 0.050 | 0.080 | 0.000 | 0.000 | 0.005 | 0.01 | 0.0015 | 6.67 | 81.2 | 7.6 | 1.63 |
| 76 | Example | 0.844 | 0.050 | 0.080 | 0.010 | 0.000 | 0.005 | 0.01 | 0.0015 | 6.67 | 81.7 | 6.9 | 1.60 |
| 77 | Example | 0.824 | 0.050 | 0.080 | 0.030 | 0.000 | 0.005 | 0.01 | 0.0015 | 6.67 | 82.5 | 5.4 | 1.58 |
| 8 | Example | 0.804 | 0.050 | 0.080 | 0.050 | 0.000 | 0.005 | 0.01 | 0.0015 | 6.67 | 82.2 | 3.6 | 1.57 |
| 78 | Example | 0.774 | 0.050 | 0.080 | 0.080 | 0.000 | 0.005 | 0.01 | 0.0015 | 6.67 | 85.4 | 2.8 | 1.54 |
| 79 | Example | 0.754 | 0.050 | 0.080 | 0.100 | 0.000 | 0.005 | 0.01 | 0.0015 | 6.67 | 86.2 | 3.1 | 1.51 |
| 80 | Comparative Example | 0.744 | 0.050 | 0.080 | 0.110 | 0.000 | 0.005 | 0.01 | 0.0015 | 6.67 | 87.3 | 4.3 | 1.46 |

### Evaluation 5

The results shown in Table 6 revealed that, even with varying P content (c), the predetermined composition simultaneously allowed high specific resistance, low coercivity, and high saturation magnetic flux density. A Comparative Example with a high P content (c) had low saturation magnetic flux density Bs and tended to have higher coercivity.

### Experiment 6

Soft magnetic alloy ribbons were prepared as in Sample No. 8 except that the Si content (d) was controlled as shown in Table 7. The ribbons were evaluated as in Sample No. 8. Table 7 shows the results.

TABLE 7

| | | | | | | | | | | | Specific | | |
|---|---|---|---|---|---|---|---|---|---|---|---|---|---|
| Sample | Example/ | | M(═Nb) | B | P | Si | C | Mn | O | | resistance | Hc | Bs |
| No. | Comparative Example | Fe | a | b | c | d | e | f | h | f/h | (μΩcm) | (A/m) | (T) |
| 8 | Example | 0.804 | 0.050 | 0.080 | 0.050 | 0.000 | 0.005 | 0.01 | 0.0015 | 6.67 | 82.2 | 3.6 | 1.57 |
| 81 | Example | 0.794 | 0.050 | 0.080 | 0.050 | 0.010 | 0.005 | 0.01 | 0.0015 | 6.67 | 81.3 | 3.9 | 1.55 |
| 82 | Example | 0.764 | 0.050 | 0.080 | 0.050 | 0.040 | 0.005 | 0.01 | 0.0015 | 6.67 | 81.5 | 3.7 | 1.54 |
| 83 | Example | 0.724 | 0.050 | 0.080 | 0.050 | 0.080 | 0.005 | 0.01 | 0.0015 | 6.67 | 82.2 | 3.6 | 1.53 |
| 84 | Example | 0.704 | 0.050 | 0.080 | 0.050 | 0.100 | 0.005 | 0.01 | 0.0015 | 6.67 | 84.8 | 3.2 | 1.52 |
| 85 | Example | 0.654 | 0.050 | 0.080 | 0.050 | 0.150 | 0.005 | 0.01 | 0.0015 | 6.67 | 85.2 | 5.2 | 1.50 |
| 86 | Comparative Example | 0.644 | 0.050 | 0.080 | 0.050 | 0.160 | 0.005 | 0.01 | 0.0015 | 6.67 | 86.2 | 5.5 | 1.45 |

### Evaluation 6

The results shown in Table 7 revealed that, even with varying Si content (d), the predetermined composition simultaneously allowed high specific resistance, low coercivity, and high saturation magnetic flux density. A Comparative Example with a high Si content (d) had low saturation magnetic flux density Bs and tended to have higher coercivity.

### Experiment 7

Soft magnetic alloy ribbons were prepared as in Sample No. 8 except that the C content (e) was controlled as shown in Table 8. The ribbons were evaluated as in Sample No. 8. Table 8 shows the results.

TABLE 8

| | | | | | | | | | | | Specific | | |
|---|---|---|---|---|---|---|---|---|---|---|---|---|---|
| Sample | Example/ | | M(═Nb) | B | P | Si | C | Mn | O | | resistance | Hc | Bs |
| No. | Comparative Example | Fe | a | b | c | d | e | f | h | f/h | (μΩcm) | (A/m) | (T) |
| 87 | Example | 0.809 | 0.050 | 0.080 | 0.050 | 0.000 | 0.000 | 0.01 | 0.0015 | 6.67 | 82.4 | 5.6 | 1.58 |
| 88 | Example | 0.808 | 0.050 | 0.080 | 0.050 | 0.000 | 0.001 | 0.01 | 0.0015 | 6.67 | 81.8 | 4.2 | 1.57 |
| 8 | Example | 0.804 | 0.050 | 0.080 | 0.050 | 0.000 | 0.005 | 0.01 | 0.0015 | 6.67 | 82.2 | 3.6 | 1.57 |
| 89 | Example | 0.799 | 0.050 | 0.080 | 0.050 | 0.000 | 0.010 | 0.01 | 0.0015 | 6.67 | 83.1 | 5.7 | 1.58 |
| 90 | Example | 0.789 | 0.050 | 0.080 | 0.050 | 0.000 | 0.020 | 0.01 | 0.0015 | 6.67 | 82.7 | 6.8 | 1.54 |
| 91 | Example | 0.779 | 0.050 | 0.080 | 0.050 | 0.000 | 0.030 | 0.01 | 0.0015 | 6.67 | 81.6 | 8.2 | 1.51 |
| 92 | Comparative Example | 0.774 | 0.050 | 0.080 | 0.050 | 0.000 | 0.035 | 0.01 | 0.0015 | 6.67 | 81.9 | 10.3 | 1.45 |

### Evaluation 7

The results shown in Table 8 revealed that, even with varying C content (e), the predetermined composition simultaneously allowed high specific resistance, low coercivity, and high saturation magnetic flux density. A Comparative Example with a high C content (e) had low saturation magnetic flux density Bs and tended to have higher coercivity.

### Experiment 8a

Alloy ribbons according to Sample Nos. 93 to 102 were prepared as in Sample No. 63 except that M was changed from Nb to an element shown in Table 9. The ribbons were evaluated as in Sample No. 63. Table 9 shows the results.

### Experiment 8b

Alloy ribbons according to Sample Nos. 103 to 112 were prepared as in Sample No. 8 except that M was changed from Nb to an element shown in Table 9. The ribbons were evaluated as in Sample No. 8. Table 9 shows the results.

### Experiment 8c

Alloy ribbons according to Sample Nos. 113 to 122 were prepared as in Sample No. 65 except that M was changed from Nb to an element shown in Table 9. The ribbons were evaluated as in Sample No. 65. Table 9 shows the results.

TABLE 9

| | | | | Specific | | |
|---|---|---|---|---|---|---|
| Sample | Example/ | M | | resistance | Hc | Bs |
| No. | Comparative Example | Element | a | (μΩcm) | (A/m) | (T) |
| 63 | Example | Nb | 0.02 | 80.5 | 8.9 | 1.62 |
| 93 | Example | Hf | 0.02 | 81.4 | 8.8 | 1.62 |
| 94 | Example | Zr | 0.02 | 80.4 | 8.1 | 1.61 |
| 95 | Example | Ta | 0.02 | 81.1 | 8.8 | 1.62 |
| 96 | Example | Ti | 0.02 | 82.5 | 7.5 | 1.60 |
| 97 | Example | Mo | 0.02 | 80.6 | 8.6 | 1.61 |
| 98 | Example | W | 0.02 | 80.0 | 7.8 | 1.60 |
| 99 | Example | V | 0.02 | 80.6 | 8.3 | 1.61 |
| 100 | Example | Nb0.5Hf0.5 | 0.02 | 80.9 | 8.5 | 1.62 |
| 101 | Example | Zr0.5Ta0.5 | 0.02 | 82.7 | 7.7 | 1.61 |
| 102 | Example | Nb0.4Hf0.3Zr0.3 | 0.02 | 81.8 | 8.7 | 1.60 |
| 8 | Example | Nb | 0.05 | 82.2 | 3.6 | 1.57 |
| 103 | Example | Hf | 0.05 | 81.3 | 4.3 | 1.56 |
| 104 | Example | Zr | 0.05 | 82.0 | 4.2 | 1.57 |
| 105 | Example | Ta | 0.05 | 81.2 | 3.6 | 1.59 |
| 106 | Example | Ti | 0.05 | 81.2 | 4.8 | 1.56 |
| 107 | Example | Mo | 0.05 | 82.6 | 3.7 | 1.57 |
| 108 | Example | W | 0.05 | 81.7 | 4.0 | 1.58 |
| 109 | Example | V | 0.05 | 83.4 | 4.5 | 1.57 |
| 110 | Example | Nb0.5Hf0.5 | 0.05 | 81.8 | 3.8 | 1.58 |
| 111 | Example | Zr0.5Ta0.5 | 0.05 | 83.4 | 4.6 | 1.58 |
| 112 | Example | Nb0.4Hf0.3Zr0.3 | 0.05 | 83.7 | 4.4 | 1.58 |
| 65 | Example | Nb | 0.10 | 80.2 | 6.8 | 1.50 |
| 113 | Example | Hf | 0.10 | 82.5 | 7.1 | 1.52 |
| 114 | Example | Zr | 0.10 | 82.0 | 6.5 | 1.52 |
| 115 | Example | Ta | 0.10 | 80.6 | 6.1 | 1.52 |
| 116 | Example | Ti | 0.10 | 80.9 | 7.5 | 1.52 |
| 117 | Example | Mo | 0.10 | 80.3 | 6.2 | 1.52 |
| 118 | Example | W | 0.10 | 80.2 | 7.1 | 1.50 |
| 119 | Example | V | 0.10 | 80.1 | 6.2 | 1.51 |
| 120 | Example | Nb0.5Hf0.5 | 0.10 | 83.0 | 6.5 | 1.51 |
| 121 | Example | Zr0.5Ta0.5 | 0.10 | 82.3 | 7.4 | 1.51 |
| 122 | Example | Nb0.4Hf0.3Zr0.3 | 0.10 | 82.2 | 7.2 | 1.52 |

### Evaluation 8

The results shown in Table 9 revealed that, even with varying M, the predetermined composition simultaneously allowed high specific resistance, low coercivity, and high saturation magnetic flux density.

### Experiment 9a

Alloy ribbons shown in Table 10A were prepared as in Sample No. 8 except that Co and/or Ni as X1 was further weighed at a ratio shown in Table 10A. The ribbons were evaluated as in Sample No. 8. Table 10A shows the results.

### Experiment 9b

Alloy ribbons shown in Tables 10B and 10C were prepared as in Sample No. 8 except that X2 including an element shown in Tables 10B and 10C was further weighed at a ratio shown in Tables 10B and 10C. The ribbons were evaluated as in Sample No. 8. Tables 10B and 10C show the results.

### Experiment 9c

Alloy ribbons shown in Tables 10D and 10E were prepared as in Sample No. 8 except that X1 and X2 including an element shown in Tables 10D and 10E were further weighed at a ratio shown in Tables 10D and 10E. The ribbons were evaluated as in Sample No. 8. Tables 10D and 10E show the results.

TABLE 10A

| | | | | Specific | | |
|---|---|---|---|---|---|---|
| Sample | Example/ | X1 | | resistance | Hc | Bs |
| No. | Comparative Example | Element | α | (μΩcm) | (A/m) | (T) |
| 8 | Example | — | 0 | 82.2 | 3.6 | 1.57 |
| 123 | Example | Co | 0.01 | 80.6 | 4.3 | 1.59 |
| 124 | Example | Co | 0.1 | 81.6 | 7.4 | 1.61 |
| 125 | Example | Co | 0.5 | 80.7 | 9.6 | 1.54 |
| 126 | Comparative Example | Co | 0.55 | 81.4 | 13.2 | 1.45 |
| 127 | Example | Ni | 0.01 | 81.9 | 3.4 | 1.56 |
| 128 | Example | Ni | 0.1 | 81.6 | 4.6 | 1.54 |
| 129 | Example | Ni | 0.5 | 81.7 | 6.2 | 1.52 |
| 130 | Comparative Example | Ni | 0.55 | 82.1 | 6.9 | 1.45 |
| 131 | Example | Co0.2Ni0.8 | 0.01 | 81.6 | 3.6 | 1.57 |
| 132 | Example | Co0.2Ni0.8 | 0.1 | 81.6 | 5.2 | 1.57 |
| 133 | Example | Co0.2Ni0.8 | 0.5 | 81.5 | 6.9 | 1.52 |
| 134 | Comparative Example | Co0.2Ni0.8 | 0.55 | 82.0 | 8.2 | 1.45 |
| 135 | Example | Co0.5Ni0.5 | 0.01 | 81.3 | 3.9 | 1.58 |
| 136 | Example | Co0.5Ni0.5 | 0.1 | 81.6 | 6.0 | 1.61 |
| 137 | Example | Co0.5Ni0.5 | 0.5 | 81.2 | 7.9 | 1.53 |
| 138 | Comparative Example | Co0.5Ni0.5 | 0.55 | 81.8 | 10.1 | 1.45 |
| 139 | Example | Co0.8Ni0.2 | 0.01 | 80.9 | 4.1 | 1.58 |
| 140 | Example | Co0.8Ni0.2 | 0.1 | 81.6 | 6.8 | 1.64 |
| 141 | Example | Co0.8Ni0.2 | 0.5 | 80.9 | 8.9 | 1.54 |
| 142 | Comparative Example | Co0.8Ni0.2 | 0.55 | 81.5 | 11.9 | 1.45 |

TABLE 10B

| | | | | Specific | | |
|---|---|---|---|---|---|---|
| Sample | Example/ | X2 | | resistance | Hc | Bs |
| No. | Comparative Example | Element | g | (μΩcm) | (A/m) | (T) |
| 8 | Example | — | 0 | 82.2 | 3.6 | 1.57 |
| 143 | Example | Al | 0.001 | 82.7 | 3.6 | 1.56 |
| 144 | Example | Al | 0.010 | 81.5 | 3.6 | 1.56 |
| 145 | Example | Al | 0.030 | 82.3 | 3.5 | 1.52 |
| 146 | Comparative Example | Al | 0.031 | 82.5 | 3.5 | 1.46 |
| 147 | Example | Ag | 0.001 | 82.2 | 3.5 | 1.57 |
| 148 | Example | Ag | 0.010 | 81.4 | 3.8 | 1.55 |
| 149 | Example | Ag | 0.030 | 82.8 | 3.8 | 1.51 |
| 150 | Comparative Example | Ag | 0.031 | 82.2 | 3.7 | 1.46 |
| 151 | Example | Zn | 0.001 | 81.7 | 3.7 | 1.56 |
| 152 | Example | Zn | 0.010 | 82.9 | 3.8 | 1.57 |
| 153 | Example | Zn | 0.030 | 82.7 | 3.5 | 1.52 |
| 154 | Comparative Example | Zn | 0.031 | 81.9 | 3.6 | 1.46 |
| 155 | Example | Sn | 0.001 | 83.5 | 3.6 | 1.56 |
| 156 | Example | Sn | 0.010 | 81.8 | 3.5 | 1.56 |
| 157 | Example | Sn | 0.030 | 81.3 | 3.4 | 1.51 |
| 158 | Comparative Example | Sn | 0.031 | 81.8 | 3.7 | 1.47 |
| 159 | Example | As | 0.001 | 83.1 | 4.0 | 1.56 |
| 160 | Example | As | 0.010 | 81.4 | 3.5 | 1.55 |
| 161 | Example | As | 0.030 | 81.0 | 3.8 | 1.52 |
| 162 | Comparative Example | As | 0.031 | 81.8 | 3.6 | 1.46 |
| 163 | Example | Sb | 0.001 | 81.4 | 3.8 | 1.56 |
| 164 | Example | Sb | 0.010 | 81.7 | 3.9 | 1.54 |
| 165 | Example | Sb | 0.030 | 82.9 | 3.7 | 1.50 |
| 166 | Comparative Example | Sb | 0.031 | 83.3 | 3.7 | 1.46 |
| 167 | Example | Cu | 0.001 | 81.4 | 3.6 | 1.55 |
| 168 | Example | Cu | 0.010 | 82.9 | 3.5 | 1.56 |
| 169 | Example | Cu | 0.030 | 81.1 | 3.5 | 1.52 |
| 170 | Comparative Example | Cu | 0.031 | 82.4 | 3.3 | 1.47 |
| 171 | Example | Cr | 0.001 | 83.4 | 3.4 | 1.57 |
| 172 | Example | Cr | 0.010 | 83.0 | 3.7 | 1.55 |
| 173 | Example | Cr | 0.030 | 83.7 | 3.7 | 1.53 |
| 174 | Comparative Example | Cr | 0.031 | 82.9 | 3.5 | 1.45 |

TABLE 10C

| | | | | Specific | | |
|---|---|---|---|---|---|---|
| Sample | Example/ | X2 | | resistance | Hc | Bs |
| No. | Comparative Example | Element | g | (μΩcm) | (A/m) | (T) |
| 175 | Example | Bi | 0.001 | 81.7 | 3.5 | 1.55 |
| 176 | Example | Bi | 0.010 | 81.6 | 3.8 | 1.56 |
| 177 | Example | Bi | 0.030 | 83.4 | 3.5 | 1.50 |
| 178 | Comparative Example | Bi | 0.031 | 82.5 | 3.8 | 1.46 |
| 179 | Example | N | 0.001 | 82.6 | 4.0 | 1.56 |
| 180 | Example | N | 0.010 | 81.1 | 3.7 | 1.55 |
| 181 | Example | N | 0.030 | 81.1 | 3.8 | 1.52 |
| 182 | Comparative Example | N | 0.031 | 82.6 | 3.9 | 1.47 |
| 183 | Example | La | 0.001 | 82.7 | 3.7 | 1.56 |
| 184 | Example | La | 0.010 | 83.6 | 3.7 | 1.55 |
| 185 | Example | La | 0.030 | 82.3 | 3.7 | 1.53 |
| 186 | Comparative Example | La | 0.031 | 82.6 | 3.4 | 1.46 |
| 187 | Example | Y | 0.001 | 83.2 | 3.6 | 1.57 |
| 188 | Example | Y | 0.010 | 83.9 | 3.4 | 1.56 |
| 189 | Example | Y | 0.030 | 82.0 | 3.4 | 1.52 |
| 190 | Comparative Example | Y | 0.031 | 82.4 | 3.3 | 1.47 |
| 191 | Example | Al0.5Zn0.5 | 0.001 | 82.2 | 3.6 | 1.56 |
| 192 | Example | Al0.5Zn0.5 | 0.010 | 82.2 | 3.7 | 1.57 |
| 193 | Example | Al0.5Zn0.5 | 0.030 | 82.5 | 3.5 | 1.52 |
| 194 | Comparative Example | Al0.5Zn0.5 | 0.031 | 82.2 | 3.6 | 1.47 |
| 195 | Example | Ag0.5Cu0.5 | 0.001 | 81.8 | 3.6 | 1.56 |
| 196 | Example | Ag0.5Cu0.5 | 0.010 | 82.2 | 3.7 | 1.56 |
| 197 | Example | Ag0.5Cu0.5 | 0.030 | 82.0 | 3.7 | 1.51 |
| 198 | Comparative Example | Ag0.5Cu0.5 | 0.031 | 82.3 | 3.5 | 1.46 |
| 199 | Example | Al0.3Cr0.4Y0.3 | 0.001 | 83.1 | 3.5 | 1.57 |
| 200 | Example | Al0.3Cr0.4Y0.3 | 0.010 | 82.8 | 3.6 | 1.56 |
| 201 | Example | Al0.3Cr0.4Y0.3 | 0.030 | 82.8 | 3.6 | 1.52 |
| 202 | Comparative Example | Al0.3Cr0.4Y0.3 | 0.031 | 82.6 | 3.4 | 1.46 |

TABLE 10D

| | | | | | | Specific | | |
|---|---|---|---|---|---|---|---|---|
| Sample | Example/ | X1 | | X2 | | resistance | Hc | Bs |
| No. | Comparative Example | Element | α | Element | g | (μΩcm) | (A/m) | (T) |
| 203 | Example | Co | 0.1 | Al | 0.010 | 81.4 | 6.9 | 1.67 |
| 204 | Example | Co | 0.1 | Ag | 0.010 | 81.8 | 6.7 | 1.66 |
| 205 | Example | Co | 0.1 | Zn | 0.010 | 81.5 | 6.9 | 1.65 |
| 206 | Example | Co | 0.1 | Sn | 0.010 | 81.9 | 7.1 | 1.66 |
| 207 | Example | Co | 0.1 | As | 0.010 | 81.0 | 6.9 | 1.66 |
| 208 | Example | Co | 0.1 | Sb | 0.010 | 80.6 | 7.0 | 1.65 |
| 209 | Example | Co | 0.1 | Cu | 0.010 | 80.5 | 7.1 | 1.66 |
| 210 | Example | Co | 0.1 | Cr | 0.010 | 81.3 | 7.1 | 1.66 |
| 211 | Example | Co | 0.1 | Bi | 0.010 | 80.8 | 7.1 | 1.66 |
| 212 | Example | Co | 0.1 | N | 0.010 | 81.6 | 6.8 | 1.64 |
| 213 | Example | Co | 0.1 | La | 0.010 | 80.5 | 7.0 | 1.67 |
| 214 | Example | Co | 0.1 | Y | 0.010 | 80.0 | 7.0 | 1.66 |
| 215 | Example | Co | 0.1 | Al0.5Zn0.5 | 0.010 | 81.5 | 6.9 | 1.66 |
| 216 | Example | Co | 0.1 | Ag0.5Cu0.5 | 0.010 | 81.2 | 6.9 | 1.66 |
| 217 | Example | Co | 0.1 | Al0.3Cr0.4Y0.3 | 0.010 | 80.9 | 7.0 | 1.66 |
| 218 | Example | Ni | 0.1 | Al | 0.010 | 81.9 | 4.2 | 1.52 |
| 219 | Example | Ni | 0.1 | Ag | 0.010 | 80.3 | 4.3 | 1.52 |
| 220 | Example | Ni | 0.1 | Zn | 0.010 | 80.1 | 4.7 | 1.53 |
| 221 | Example | Ni | 0.1 | Sn | 0.010 | 80.0 | 4.3 | 1.52 |
| 222 | Example | Ni | 0.1 | As | 0.010 | 81.1 | 4.2 | 1.51 |
| 223 | Example | Ni | 0.1 | Sb | 0.010 | 81.8 | 4.1 | 1.51 |
| 224 | Example | Ni | 0.1 | Cu | 0.010 | 80.8 | 4.3 | 1.53 |
| 225 | Example | Ni | 0.1 | Cr | 0.010 | 81.6 | 4.5 | 1.53 |
| 226 | Example | Ni | 0.1 | Bi | 0.010 | 80.1 | 4.5 | 1.53 |
| 227 | Example | Ni | 0.1 | N | 0.010 | 81.5 | 4.6 | 1.52 |
| 228 | Example | Ni | 0.1 | La | 0.010 | 80.5 | 4.6 | 1.52 |
| 229 | Example | Ni | 0.1 | Y | 0.010 | 80.8 | 4.3 | 1.53 |
| 230 | Example | Ni | 0.1 | Al0.5Zn0.5 | 0.010 | 81.0 | 4.5 | 1.53 |
| 231 | Example | Ni | 0.1 | Ag0.5Cu0.5 | 0.010 | 80.6 | 4.3 | 1.53 |
| 232 | Example | Ni | 0.1 | Al0.3Cr0.4Y0.3 | 0.010 | 81.5 | 4.4 | 1.53 |

TABLE 10E

| | | | | | | Specific | | |
|---|---|---|---|---|---|---|---|---|
| Sample | Example/ | X1 | | X2 | | resistance | Hc | Bs |
| No. | Comparative Example | Element | α | Element | g | (μΩcm) | (A/m) | (T) |
| 233 | Example | Co0.2Ni0.8 | 0.1 | Al | 0.010 | 81.8 | 4.7 | 1.55 |
| 234 | Example | Co0.2Ni0.8 | 0.1 | Ag | 0.010 | 80.6 | 4.8 | 1.55 |
| 235 | Example | Co0.2Ni0.8 | 0.1 | Zn | 0.010 | 80.4 | 5.1 | 1.55 |
| 236 | Example | Co0.2Ni0.8 | 0.1 | Sn | 0.010 | 80.4 | 4.9 | 1.55 |
| 237 | Example | Co0.2Ni0.8 | 0.1 | As | 0.010 | 81.1 | 4.7 | 1.54 |
| 238 | Example | Co0.2Ni0.8 | 0.1 | Sb | 0.010 | 81.6 | 4.7 | 1.54 |
| 239 | Example | Co0.2Ni0.8 | 0.1 | Cu | 0.010 | 80.7 | 4.9 | 1.56 |
| 240 | Example | Co0.2Ni0.8 | 0.1 | Cr | 0.010 | 81.5 | 5 | 1.56 |
| 241 | Example | Co0.2Ni0.8 | 0.1 | Bi | 0.010 | 80.2 | 5 | 1.56 |
| 242 | Example | Co0.2Ni0.8 | 0.1 | N | 0.010 | 81.5 | 5 | 1.54 |
| 243 | Example | Co0.2Ni0.8 | 0.1 | La | 0.010 | 80.5 | 5.1 | 1.55 |
| 244 | Example | Co0.2Ni0.8 | 0.1 | Y | 0.010 | 80.6 | 4.8 | 1.56 |
| 245 | Example | Co0.2Ni0.8 | 0.1 | Al0.5Zn0.5 | 0.010 | 81.1 | 4.9 | 1.55 |
| 246 | Example | Co0.2Ni0.8 | 0.1 | Ag0.5Cu0.5 | 0.010 | 80.7 | 4.9 | 1.56 |
| 247 | Example | Co0.2Ni0.8 | 0.1 | Al0.3Cr0.4Y0.3 | 0.010 | 81.3 | 4.9 | 1.56 |
| 248 | Example | Co0.5Ni0.5 | 0.1 | Al | 0.010 | 81.7 | 5.6 | 1.60 |
| 249 | Example | Co0.5Ni0.5 | 0.1 | Ag | 0.010 | 81.1 | 5.5 | 1.59 |
| 250 | Example | Co0.5Ni0.5 | 0.1 | Zn | 0.010 | 80.8 | 5.8 | 1.59 |
| 251 | Example | Co0.5Ni0.5 | 0.1 | Sn | 0.010 | 81 | 5.7 | 1.59 |
| 252 | Example | Co0.5Ni0.5 | 0.1 | As | 0.010 | 81.1 | 5.6 | 1.59 |
| 253 | Example | Co0.5Ni0.5 | 0.1 | Sb | 0.010 | 81.2 | 5.6 | 1.58 |
| 254 | Example | Co0.5Ni0.5 | 0.1 | Cu | 0.010 | 80.7 | 5.7 | 1.60 |
| 255 | Example | Co0.5Ni0.5 | 0.1 | Cr | 0.010 | 81.5 | 5.8 | 1.60 |
| 256 | Example | Co0.5Ni0.5 | 0.1 | Bi | 0.010 | 80.5 | 5.8 | 1.60 |
| 257 | Example | Co0.5Ni0.5 | 0.1 | N | 0.010 | 81.6 | 5.7 | 1.58 |
| 258 | Example | Co0.5Ni0.5 | 0.1 | La | 0.010 | 80.5 | 5.8 | 1.60 |
| 259 | Example | Co0.5Ni0.5 | 0.1 | Y | 0.010 | 80.4 | 5.7 | 1.60 |
| 260 | Example | Co0.2Ni0.8 | 0.1 | Al0.5Zn0.5 | 0.010 | 81.3 | 5.7 | 1.60 |
| 261 | Example | Co0.2Ni0.8 | 0.1 | Ag0.5Cu0.5 | 0.010 | 80.9 | 5.6 | 1.60 |
| 262 | Example | Co0.2Ni0.8 | 0.1 | Al0.3Cr0.4Y0.3 | 0.010 | 81.2 | 5.7 | 1.60 |
| 263 | Example | Co0.8Ni0.2 | 0.1 | Al | 0.010 | 81.5 | 6.4 | 1.64 |
| 264 | Example | Co0.8Ni0.2 | 0.1 | Ag | 0.010 | 81.5 | 6.2 | 1.63 |
| 265 | Example | Co0.8Ni0.2 | 0.1 | Zn | 0.010 | 81.2 | 6.5 | 1.63 |
| 266 | Example | Co0.8Ni0.2 | 0.1 | Sn | 0.010 | 81.5 | 6.5 | 1.63 |
| 267 | Example | Co0.8Ni0.2 | 0.1 | As | 0.010 | 81.0 | 6.4 | 1.63 |
| 268 | Example | Co0.8Ni0.2 | 0.1 | Sb | 0.010 | 80.8 | 6.4 | 1.62 |
| 269 | Example | Co0.8Ni0.2 | 0.1 | Cu | 0.010 | 80.6 | 6.5 | 1.63 |
| 270 | Example | Co0.8Ni0.2 | 0.1 | Cr | 0.010 | 81.4 | 6.6 | 1.63 |
| 271 | Example | Co0.8Ni0.2 | 0.1 | Bi | 0.010 | 80.7 | 6.6 | 1.63 |
| 272 | Example | Co0.8Ni0.2 | 0.1 | N | 0.010 | 81.6 | 6.4 | 1.62 |
| 273 | Example | Co0.8Ni0.2 | 0.1 | La | 0.010 | 80.5 | 6.5 | 1.64 |
| 274 | Example | Co0.8Ni0.2 | 0.1 | Y | 0.010 | 80.2 | 6.5 | 1.63 |
| 275 | Example | Co0.2Ni0.8 | 0.1 | Al0.5Zn0.5 | 0.01 | 81.4 | 6.5 | 1.64 |
| 276 | Example | Co0.2Ni0.8 | 0.1 | Ag0.5Cu0.5 | 0.01 | 81.1 | 6.4 | 1.63 |
| 277 | Example | Co0.2Ni0.8 | 0.1 | Al0.3Cr0.4Y0.3 | 0.01 | 81.1 | 6.5 | 1.63 |

### Evaluation 9

The results shown in Tables 10A to 10E revealed that, even with X1 or X2 within a predetermined range, the predetermined composition simultaneously allowed high specific resistance, low coercivity, and high saturation magnetic flux density. In contrast, the ribbons of Comparative Examples with a high “α” had low saturation magnetic flux density Bs. The ribbons of Comparative Examples with a high “g” had low saturation magnetic flux density Bs and tended to have higher coercivity.

### Experiment 10

Alloy ribbons shown in Table 11 were prepared as in Sample No. 8 except that conditions of the crystallization heat treatment were changed as shown in Table 11. The ribbons were evaluated as in Sample No. 8. Table 11 shows the results.

As for the alloy ribbon according to each sample number shown in Table 11, the average crystallite size was found using an X-ray diffraction measurement. Table 11 shows the results.

TABLE 11

| | | Crystallization | | Average | | | |
|---|---|---|---|---|---|---|---|
| | | heat treatment | | crystallite | Specific | | |
| Sample | Example/ | Temperature | Time | size | resistance | Hc | Bs |
| No. | Comparative Example | (° C.) | (min) | (nm) | (μΩcm) | (A/m) | (T) |
| 278 | Example | 500 | 60 | 3 | 82.0 | 3.7 | 1.51 |
| 279 | Example | 550 | 60 | 5 | 81.7 | 4.6 | 1.56 |
| 280 | Example | 575 | 60 | 9 | 82.6 | 3.5 | 1.57 |
| 8 | Example | 600 | 60 | 14 | 82.2 | 3.6 | 1.57 |
| 281 | Example | 650 | 60 | 30 | 82.6 | 7.6 | 1.58 |
| 282 | Example | 650 | 600 | 50 | 81.1 | 9.4 | 1.60 |
| 283 | Example | 650 | 900 | 72 | 81.8 | 13.8 | 1.60 |

### Evaluation 10

The results shown in Table 11 revealed that, even with varying average crystallite size, the predetermined composition simultaneously allowed high specific resistance, low coercivity, and high saturation magnetic flux density. It was also found that the larger the average crystallite size, the higher the coercivity tended to be, and that the preferable average crystallite size was 50 nm or less.

### Experiment 11

Alloy ribbons shown in Tables 12A and 12B were prepared as in Sample No. 8 except that the rotation speed of the roll or the gap between the roll and the nozzle was changed to control the thicknesses of the alloy ribbons and that the short side length T of the spray port of the quenching nozzle was controlled to make the ribbons have the same composition. The ribbons were evaluated as in Sample No. 8. Tables 12A and 12B show the results.

TABLE 12A

| | | Ribbon | MnO | Specific | | |
|---|---|---|---|---|---|---|
| Sample | Example/ | thickness | depth | resistance | Hc | Bs |
| No. | Comparative Example | (μm) | (nm) | (μΩcm) | (A/m) | (T) |
| 283 | Example | 1 | 5 | 82.7 | 3.5 | 1.57 |
| 284 | Example | 10 | 5 | 80.8 | 3.2 | 1.58 |
| 285 | Example | 15 | 5 | 80.4 | 3.4 | 1.59 |
| 4 | Example | 20 | 5 | 80.2 | 3.5 | 1.59 |
| 286 | Example | 25 | 5 | 80.2 | 3.8 | 1.60 |
| 287 | Example | 30 | 5 | 80.1 | 3.4 | 1.60 |
| 288 | Example | 50 | 5 | 80.1 | 3.5 | 1.61 |
| 289 | Example | 75 | 5 | 80.0 | 3.7 | 1.61 |
| 290 | Example | 100 | 5 | 80.0 | 3.7 | 1.61 |
| 291 | Example | 110 | 5 | 76.3 | 3.8 | 1.61 |
| 292 | Example | 1 | 10 | 83.8 | 3.5 | 1.55 |
| 293 | Example | 10 | 10 | 81.9 | 3.3 | 1.57 |
| 294 | Example | 15 | 10 | 81.5 | 3.4 | 1.58 |
| 5 | Example | 20 | 10 | 81.3 | 3.7 | 1.58 |
| 295 | Example | 25 | 10 | 81.1 | 3.9 | 1.59 |
| 296 | Example | 30 | 10 | 81.0 | 3.4 | 1.60 |
| 297 | Example | 50 | 10 | 80.5 | 3.6 | 1.60 |
| 298 | Example | 75 | 10 | 80.2 | 3.7 | 1.60 |
| 299 | Example | 100 | 10 | 80.0 | 3.7 | 1.61 |
| 300 | Example | 110 | 10 | 76.5 | 3.7 | 1.61 |
| 301 | Example | 1 | 20 | 84.0 | 3.5 | 1.55 |
| 302 | Example | 10 | 20 | 82.1 | 3.3 | 1.57 |
| 303 | Example | 15 | 20 | 81.7 | 3.3 | 1.58 |
| 6 | Example | 20 | 20 | 81.5 | 3.6 | 1.58 |
| 304 | Example | 25 | 20 | 81.3 | 3.8 | 1.59 |
| 305 | Example | 30 | 20 | 81.2 | 3.3 | 1.58 |
| 306 | Example | 50 | 20 | 80.7 | 3.7 | 1.59 |
| 307 | Example | 75 | 20 | 80.4 | 3.7 | 1.60 |
| 308 | Example | 100 | 20 | 80.1 | 3.6 | 1.59 |
| 309 | Example | 110 | 20 | 76.9 | 3.7 | 1.60 |
| 310 | Example | 1 | 25 | 84.3 | 3.1 | 1.55 |
| 311 | Example | 10 | 25 | 82.4 | 3.0 | 1.57 |
| 312 | Example | 15 | 25 | 82.0 | 3.1 | 1.58 |
| 7 | Example | 20 | 25 | 81.8 | 3.4 | 1.58 |
| 313 | Example | 25 | 25 | 81.6 | 3.4 | 1.59 |
| 314 | Example | 30 | 25 | 81.5 | 3.0 | 1.58 |
| 315 | Example | 50 | 25 | 81.0 | 3.4 | 1.59 |
| 316 | Example | 75 | 25 | 80.7 | 3.5 | 1.60 |
| 317 | Example | 100 | 25 | 80.4 | 3.2 | 1.59 |
| 318 | Example | 110 | 25 | 77.2 | 3.4 | 1.60 |

TABLE 12B

| | | Ribbon | MnO | Specific | | |
|---|---|---|---|---|---|---|
| Sample | Example/ | thickness | depth | resistance | Hc | Bs |
| No. | Comparative Example | (μm) | (nm) | (μΩcm) | (A/m) | (T) |
| 319 | Example | 1 | 40 | 84.7 | 3.2 | 1.54 |
| 320 | Example | 10 | 40 | 82.8 | 3.2 | 1.56 |
| 321 | Example | 15 | 40 | 82.4 | 3.1 | 1.58 |
| 8 | Example | 20 | 40 | 82.2 | 3.6 | 1.57 |
| 322 | Example | 25 | 40 | 82.0 | 3.5 | 1.59 |
| 323 | Example | 30 | 40 | 81.9 | 3.1 | 1.58 |
| 324 | Example | 50 | 40 | 81.4 | 3.4 | 1.59 |
| 325 | Example | 75 | 40 | 81.1 | 3.6 | 1.60 |
| 326 | Example | 100 | 40 | 80.8 | 3.3 | 1.59 |
| 327 | Example | 110 | 40 | 77.5 | 3.6 | 1.60 |
| 328 | Example | 1 | 60 | 89.1 | 3.4 | 1.53 |
| 329 | Example | 10 | 60 | 87.0 | 3.5 | 1.54 |
| 330 | Example | 15 | 60 | 86.7 | 3.4 | 1.55 |
| 9 | Example | 20 | 60 | 86.4 | 3.8 | 1.56 |
| 331 | Example | 25 | 60 | 86.2 | 3.8 | 1.57 |
| 332 | Example | 30 | 60 | 86.0 | 3.3 | 1.57 |
| 333 | Example | 50 | 60 | 85.6 | 3.6 | 1.57 |
| 334 | Example | 75 | 60 | 85.2 | 3.7 | 1.58 |
| 335 | Example | 100 | 60 | 85.0 | 3.6 | 1.59 |
| 336 | Example | 110 | 60 | 78.1 | 3.9 | 1.59 |
| 337 | Example | 1 | 100 | 97.4 | 4.4 | 1.50 |
| 338 | Example | 10 | 100 | 95.2 | 4.5 | 1.50 |
| 339 | Example | 15 | 100 | 94.8 | 4.4 | 1.51 |
| 13 | Example | 20 | 100 | 94.5 | 4.7 | 1.51 |
| 340 | Example | 25 | 100 | 94.3 | 4.7 | 1.51 |
| 341 | Example | 30 | 100 | 94.1 | 4.4 | 1.51 |
| 342 | Example | 50 | 100 | 93.6 | 4.6 | 1.52 |
| 343 | Example | 75 | 100 | 93.2 | 4.6 | 1.53 |
| 344 | Example | 100 | 100 | 92.9 | 4.6 | 1.54 |
| 345 | Example | 110 | 100 | 79.2 | 4.9 | 1.55 |

### Evaluation 11

The results shown in Tables 12A and 12B revealed that, even with varying thicknesses of the ribbons, the predetermined composition simultaneously allowed high specific resistance, low coercivity, and high saturation magnetic flux density.

### Experiment 12

Alloy ribbons according to Sample Nos. 347 and 349 were prepared as in Sample No. 63 except that the temperature of a heat treatment corresponding to the crystallization heat treatment was changed to a value shown in Table 13. The ribbons were evaluated as in Sample No. 63. Alloy ribbons according to Sample Nos. 346, 348, and 350 were prepared as in Sample No. 347, 349, and 63 except that no quenching with quenching water was performed. The ribbons were evaluated as in Sample No. 63. Table 13 shows the results.

TABLE 13

| | | Quenching | | | | | | | | |
|---|---|---|---|---|---|---|---|---|---|---|
| | | nozzle | Heat | | | | | | | |
| | | Short side | treatment | | | Specific | | | | MnO |
| Sample | Example/ | length | Temperature | Time | | resistance | Hc | Bs | Mn | depth |
| No. | Comparative Example | of nozzle | (° C.) | (min) | Phase | (μΩcm) | (A/m) | (T) | state | nm |
| 346 | Comparative Example | No quenching | 400 | 60 | Amorphous solid phase | 73.3 | 12.3 | 1.48 | Mn | — |
| 347 | Example | 0.50 mm | 400 | 60 | Amorphous solid phase | 83.1 | 9.5 | 1.51 | Mn—O | 16 |
| 348 | Comparative Example | No quenching | 500 | 60 | Amorphous solid phase + | 72.2 | 10.3 | 1.58 | Mn | — |
| | | | | | Fine crystal | | | | | |
| 349 | Example | 0.50 mm | 500 | 60 | Amorphous solid phase + | 82.4 | 9.8 | 1.60 | Mn—O | 12 |
| | | | | | Fine crystal | | | | | |
| 350 | Comparative Example | No quenching | 600 | 60 | Nanocrystal | 70.3 | 9.3 | 1.60 | Mn | — |
| 63 | Example | 0.50 mm | 600 | 60 | Nanocrystal | 80.5 | 8.9 | 1.62 | Mn—O | 10 |

### Evaluation 12

The results shown in Table 13 revealed that a low temperature of the heat treatment provided an amorphous structure or a structure including an amorphous solid with fine crystals. Meanwhile, it was found that, even when the ribbons had an amorphous structure or a structure including an amorphous solid with fine crystals, the predetermined composition simultaneously allowed high specific resistance, low coercivity, and high saturation magnetic flux density compared to those of Comparative Examples. It was found that, in particular, when the ribbons had a nanocrystalline structure, high saturation magnetic flux density was achievable.

### REFERENCE NUMERALS

31 . . . nozzle
32 . . . molten metal
33 . . . roll
34 . . . ribbon
35 . . . chamber
36 . . . quenching nozzle
36a . . . spray port
37 . . . gas spraying mechanism

What is claimed is:

1. A soft magnetic alloy comprising a main component having a composition formula (Fe_{(1-α)}X1_{α})_{(1-(a+b+c+d+e+f+g+h))}MₐB_{b}P_{c}Si_{d}CₑMn_{f}X2_{g}Oₕ, where
X1 comprises at least one selected from the group consisting of Co and Ni,
X2 comprises at least one selected from the group consisting of Al, Ag, Zn, Sn, As, Sb, Cu, Cr, Bi, N, and a rare earth element,
M comprises at least one selected from the group consisting of Nb, Hf, Zr, Ta, Ti, Mo, W, and V, and
$$\begin{matrix}0.02 \leq a \leq 0.10 , \\ 0.02 \leq b \leq 0.2 , \\ 0 \leq c \leq 0.10 , \\ 0 \leq d \leq 0.15 , \\ 0 \leq e \leq 0.03 , \\ 0 < f \leq 0.02 , \\ 0 \leq g \leq 0.03 , \\ 0.0001 \leq h \leq 0.0 \; 12 , \\ 0.05 \leq f / h \leq 100 , and \\ 0 \leq α \leq 0.5\end{matrix}$$
are satisfied.

2. The soft magnetic alloy according to claim 1, wherein 0.730≤1−(a+b+c+d+e+f+g+h)≤0.918 is satisfied.

3. The soft magnetic alloy according to claim 1, comprising a Mn oxide.

4. The soft magnetic alloy according to claim 3, comprising a region comprising the Mn oxide at or within 100 nm from a surface of the soft magnetic alloy.

5. The soft magnetic alloy according to claim 1, having a nanocrystalline structure.

6. The soft magnetic alloy according to claim 5, wherein the nanocrystalline structure comprises nanocrystals with an average crystallite size of 50 nm or less.

7. A soft magnetic alloy ribbon comprising the soft magnetic alloy according to claim 1.

8. The soft magnetic alloy ribbon according to claim 7, having a thickness of 1 μm or more and 100 μm or less.

9. A magnetic device comprising the soft magnetic alloy according to claim 1.

10. A magnetic device comprising the soft magnetic alloy ribbon according to claim 7.
